(19) United States
(12) Patent Application Publication
(10) Pub. No.: US 2026/0134589 A1
(43) Pub. Date: May 14, 2026

(54) SYSTEMS AND METHODS FOR RELIGHTED IMAGE GENERATION

(71) Applicant: ADOBE INC., SAN JOSE, CA (US)

(72) Inventors: Junuk Cha, Haman-gun (KR); Jae Shin Yoon, San Jose, CA (US); Mengwei Ren, San Jose, CA (US); Krishna Kumar Singh, San Jose, CA (US); Seunghyun Yoon, San Jose, CA (US); He Zhang, Santa Clara, CA (US); Yannick Hold-Geoffroy, Québec (CA); HyunJoon Jung, Monte Sereno, CA (US)

(21) Appl. No.: 18/947,407

(22) Filed: Nov. 14, 2024

(51) Int. Cl. G06T 11/00; G06F 40/40; G06T 5/50; G06T 5/70; G06T 7/55

(52) U.S. Cl. CPC G06T 11/10; G06T 5/50; G06T 5/70; G06T 7/55; G06F 40/40; G06T 2207/20081

(57) ABSTRACT

A method, apparatus, non-transitory computer readable medium, and system for image generation includes obtaining a source image and a lighting input that indicates a lighting condition for the source image. An image generation model generates a relighted foreground image based on the source image. A relighted background image is also generated based on the lighting input. The relighted foreground image depicts a foreground element with the lighting condition and the relighted background image depicts a background element with the lighting condition. The relighted foreground image and the relighted background image are combined to obtain a relighted image, wherein the relighted image depicts the foreground element and the background element with the lighting condition.

### BACKGROUND

The following relates generally to image generation, and more specifically to image relighting. Machine learning algorithms build a model based on sample data, known as training data, to make a prediction or a decision in response to an input without being explicitly programmed to do so. One area of application for machine learning is image generation.

Machine learning models can be used to generate images based on input guidance provided by text or images. Image relighting refers to a process of replacing a lighting condition of an input image with a novel lighting condition in a relighted image.

### SUMMARY

Systems and methods are described for generating a relighted image by relighting a scene according to a lighting condition. In some embodiments, the relighted image is generated by relighting a foreground with the lighting condition according to a foreground relighting process, relighting a background with the lighting condition according to a background relighting process, and combining the relighted foreground and the relighted background. Therefore, by separately relighting the foreground and background, embodiments of the present disclosure improve on conventional image generation systems by obtaining a relighted image that accurately depicts a lighting condition across both the foreground and the background.

Some embodiments include obtaining a source image and a lighting input, wherein the lighting input indicates a lighting condition for the source image; generating, using an image generation model, a relighted foreground image and a relighted background image based on the source image and on the lighting input, wherein the relighted foreground image depicts a foreground element with the lighting condition and the relighted background image depicts a background element with the lighting condition; and combining the relighted foreground image and the relighted background image to obtain a relighted image, wherein the relighted image depicts the foreground element and the background element with the lighting condition, based on the source image.

In some embodiments, the relighted image is generated using an image generation model trained to generate the relighted image based on a text prompt describing a relighting object corresponding to the lighting condition. Therefore, embodiments of the present disclosure improve on conventional image generation systems by providing an image generation model that generates a relighted image that accurately depicts a lighting condition corresponding to a relighted object described by the prompt.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for generating a relighted image according to aspects of the present disclosure.

FIG. 3 shows an example of a comparative generated image.

FIG. 4 shows an example of an image generation system that generates a relighted image using a foreground image relighting process and a background image relighting process according to aspects of the present disclosure.

FIG. 5 shows an example of an image generation system that generates a lighting image according to aspects of the present disclosure.

FIG. 6 shows an example of an image generation system that generates a lighting input according to aspects of the present disclosure.

FIG. 7 shows an example of an image generation system that employs a foreground image relighting method according to aspects of the present disclosure.

FIG. 8 shows an example of an image generation system that employs a foreground image relighting method based on a panoramic image according to aspects of the present disclosure.

FIG. 9 shows an example of an image generation system that employs a background image relighting method according to aspects of the present disclosure.

FIG. 10 shows an example of a guided diffusion model according to aspects of the present disclosure.

FIG. 11 shows an example of a U-Net according to aspects of the present disclosure.

FIG. 12 shows an example of a transformer according to aspects of the present disclosure.

FIG. 13 shows an example of a method for generating a relighted image based on a lighting image according to aspects of the present disclosure.

FIG. 14 shows an example of a method for generating a relighted image using a diffusion process according to aspects of the present disclosure.

FIG. 15 shows an example of a diffusion process according to aspects of the present disclosure.

FIG. 16 shows an example of a method for training an image generation model according to aspects of the present disclosure.

FIG. 17 shows an example of a flow diagram depicting an algorithm as a step-by-step procedure for training a machine learning model according to aspects of the present disclosure.

FIG. 18 shows an example of a method for training a diffusion model according to aspects of the present disclosure.

FIG. 19 shows an example of a computing device according to aspects of the present disclosure.

FIG. 20 shows an example of an example implementation of an image generation apparatus according to aspects of the present disclosure.

### DETAILED DESCRIPTION

### Overview

The following relates to image relighting using machine learning. Image relighting refers to a process of replacing a lighting condition (e.g., a visual characteristic of lighting included in an image) of an input image with a novel lighting condition in a relighted image. Image relighting may be accomplished using image rendering or machine learning processes. However, conventional image rendering processes are inefficient or do not generate accurate relighted images.

Accordingly, aspects of the present disclosure generate a relighted image by relighting a scene according to a lighting condition. In some embodiments, the relighted image is generated by relighting a foreground to have the lighting condition according to a foreground relighting process, relighting a background to have the lighting condition according to a background relighting process, and combining the relighted foreground and the relighted background.

By contrast, conventional image relighting systems that use image rendering techniques may focus on relighting a foreground, rather than an image as a whole, and may require specialized physical infrastructure for capturing images of an object, and/or expensive graphics simulation, which is not scalable or accessible to a general user. Furthermore, these relighting systems are not designed to be generalizable to diverse scenes and arbitrary objects, which also highly limits their usefulness. By separately relighting the foreground and background, embodiments of the present disclosure improve on conventional image generation systems by obtaining a relighted image that accurately depicts a lighting condition across both the foreground and the background, while being scalable and generalizable.

In some embodiments, the relighted image is generated using an image generation model trained to generate the relighted image based on a text prompt describing a relighting object corresponding to the lighting condition. For example, in a text prompt “The blue light of the computer monitor”, the relighting object is the computer monitor. By contrast, conventional image generation models are not trained to generate relighted images based on a description of a relighting object, and therefore generate relighted images depicting unwanted new content, rather than new lighting. By training the image generation model based on the text prompt describing the relighting object corresponding to the lighting condition, embodiments of the present disclosure are able to provide accurate relighted images that do not introduce unwanted new content in the relighted image.

An example of the present disclosure are used in an image generation context. In the example, a user provides a subject image and a lighting input (e.g., a text prompt) to an image generation system, where the subject image depicts a person (a foreground element) in front of an apartment wall (a background element) with yellow lighting from a ceiling lamp, and the text prompt includes “The blue light of the computer monitor”, where “the computer monitor” is a relighting object and “the blue light of the computer monitor” is a corresponding lighting condition. The image generation system uses an image generation model (e.g., a diffusion model) to generate a relighted image that depicts the same foreground element and background element as the subject image, with blue lighting that appears to be provided from a computer monitor. The computer monitor is not depicted in the subject image, and the image generation model does not introduce the computer monitor in the relighted image.

Another example of the present disclosure is also used in an image generation context. In the example, a language generation model generates a text prompt “The golden hour light of the sun highlighted the beauty of the mountain scenery, creating a spellbinding view” in response to an instruction from the image generation system. The image generation system uses a lighting image generation model to generate an image based on the text prompt. The image generation system extracts a foreground element (a person) and a background element (a house exterior) from a source image depicting the foreground element and the background element.

The image generation system generates a relighted foreground image by relighting the foreground element based on the lighting image using a foreground image relighting model and generates a relighted background image by relighting the background element based on the lighting image using a background image relighting model. The image generation system generates a relighted image by compositing the relighted foreground image with the relighted background image. The text prompt and the relighted image may also be used as training data for training the image generation model to generate a subsequent relighted image based on a text prompt.

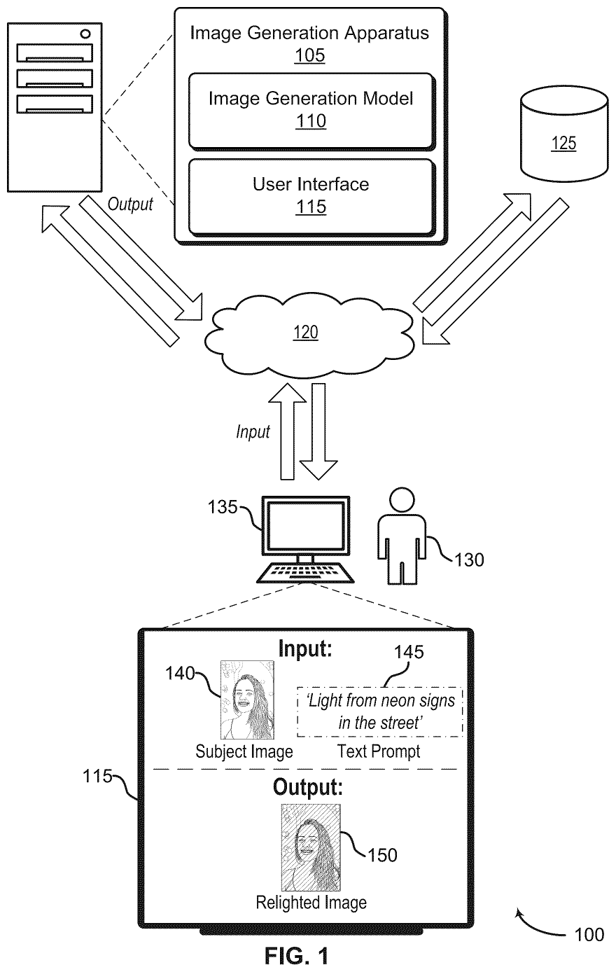

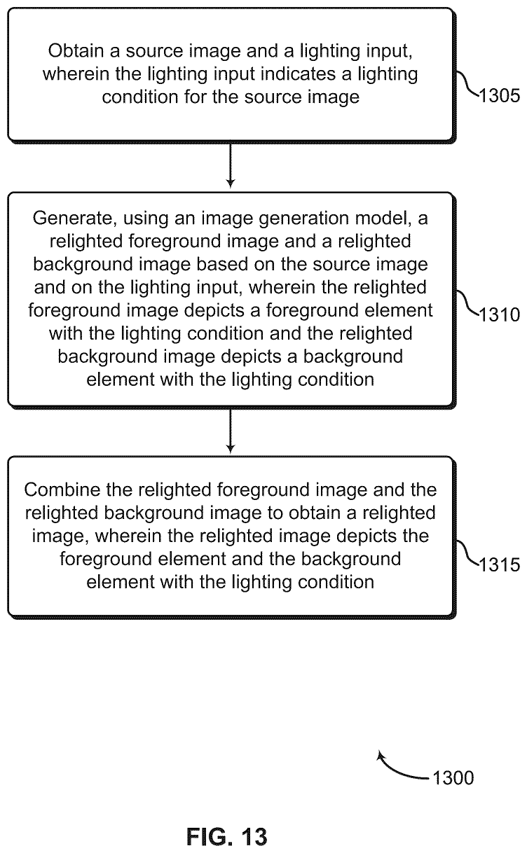

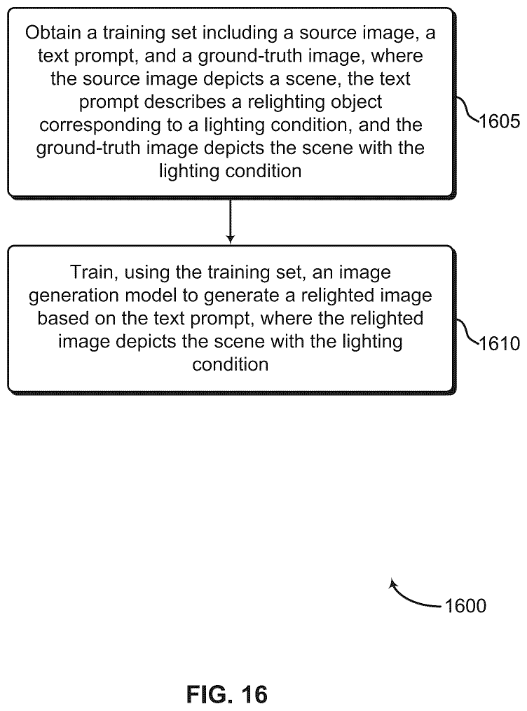

Further example applications of the present disclosure in an image generation context are provided with reference to FIGS. 1-3. Details regarding the architecture of the image generation system are provided with reference to FIGS. 1-12 and 19-20. Examples of a process for generating a relighted image are provided with reference to FIGS. 13-15. Examples of a process for training a machine learning model are provided with reference to FIGS. 16-18.

Embodiments of the present disclosure improve upon conventional image generation systems by making an image relighting process more efficient and accurate. For example, some embodiments achieve this efficiency and accuracy by relighting a foreground with the lighting condition according to a foreground relighting process, relighting a background with the lighting condition according to a background relighting process, and combining the relighted foreground and the relighted background, or by training an image generation model to generate a relighted image based on a text prompt describing a relighting object corresponding to a lighting condition.

By contrast, conventional image relighting systems that use image rendering techniques may focus on relighting a foreground, rather than an image as a whole, and may require specialized physical infrastructure for capturing images of an object, and/or expensive graphics simulation, which is not scalable or accessible to a general user. Furthermore, these relighting systems are not designed to be generalizable to diverse scenes and arbitrary objects, which also highly limits their usefulness. Additionally, conventional image generation models are not trained to generate relighted images based on a description of a relighting object, and therefore generate relighted images depicting unwanted new content, rather than new lighting.

### Image Generation System

FIG. 1 shows an example of an image generation system 100 according to aspects of the present disclosure. The example shown includes image generation system 100, user 130, user device 135, subject image 140, text prompt 145, and relighted image 150. In one aspect, image generation system 100 includes image generation apparatus 105, cloud 120, and database 125. In one aspect, image generation apparatus 105 includes image generation model 110 and user interface 115.

In the example of FIG. 1, user 130 provides subject image 140 and text prompt 145 to image generation apparatus 105 via user interface 115 presented on user device 135. Subject image 140 is a portrait image depicting a portrait of a person against a background. Text prompt 145 describes a lighting condition “light from neon signs in the street” corresponding to a relighting object “neon signs”. Image generation apparatus 105 generates relighted image 150 based on subject image 140 and text prompt 145.

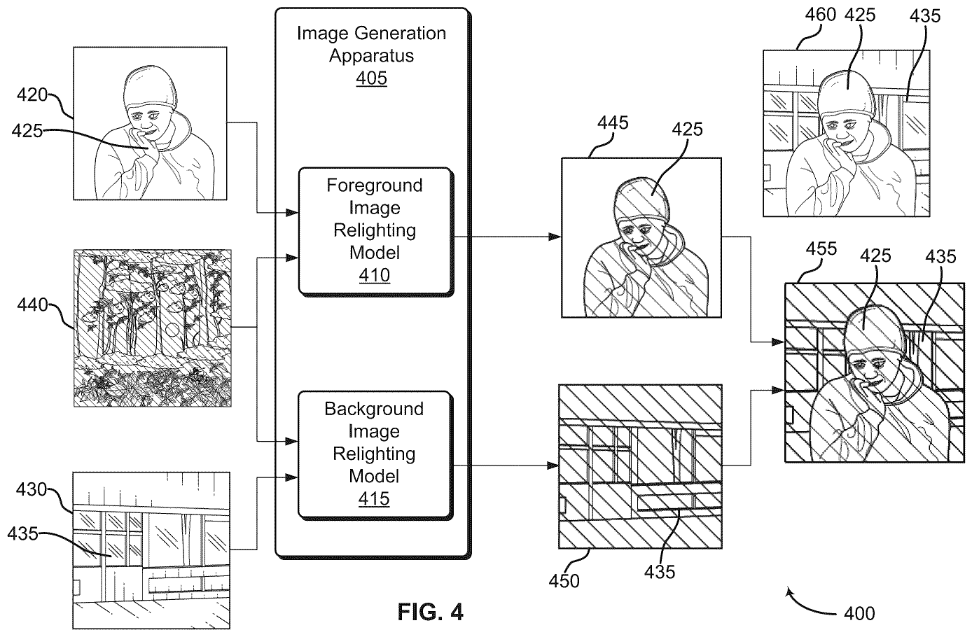

Alternatively, in some embodiments, user 130 provides a lighting image depicting a lighting condition, or image generation apparatus generates the lighting image based on text prompt 145. Image generation apparatus 105 extracts a foreground element (e.g., the person) and the background element (e.g., the background) from subject image 140, separately relights the foreground element and the background element according to the lighting condition using the lighting image, and combines the relighted foreground element and the relighted background element to obtain relighted image 150, as described in further detail with reference to FIG. 4.

A “foreground image” refers to an image depicting a “foreground element”, and a “background image” refers to an image depicting a “background element”. A “foreground element” is one or more objects depicted in a foreground of an image, and a “background element” is one or more objects depicted in a background of an image. A “source image” or a “subject image” refers to an image depicting a foreground element, a background element, or a combination thereof.

A “lighting image” refers to an image depicting a “lighting condition”. A “lighting input” refers to an input (e.g., a text prompt or an image prompt) that indicates the lighting condition for the source image. A “lighting condition” refers to a characteristic relating to lighting information from an image (such as color, position, direction, intensity, etc.). A lighting condition may be expressed by a text prompt. For example, in a text prompt “Blue light from a computer monitor”, the lighting condition is described by the entire text prompt, and an image that depicts the lighting condition includes content that appears to be lit by blue light from a computer monitor. A lighting condition is distinct from “content”, which refers to a shape and/or intrinsic appearance of an object depicted in an image. An element depicted “with a lighting condition” is an element that is depicted as being lighted according to the lighting condition.

A “relighted foreground image” refers to an image that depicts a foreground element according to a different lighting condition than another image depicting the foreground element. A “relighted background image” refers to an image that depicts a background element according to a different lighting condition than another image depicting the background element. A “relighted image” refers to an image that depicts a “scene” (e.g., a combination of one or more of a foreground element and a background element) according to a different lighting condition than another image or images depicting the foreground element, the background element, or a combination thereof.

A “relighting object” refers to an object that corresponds to a lighting condition. A relighting object may be described by a text prompt. In an example text prompt, “The blue light of the computer monitor”, “the computer monitor” is a relighting object that corresponds to the lighting condition “the blue light of the computer monitor”.

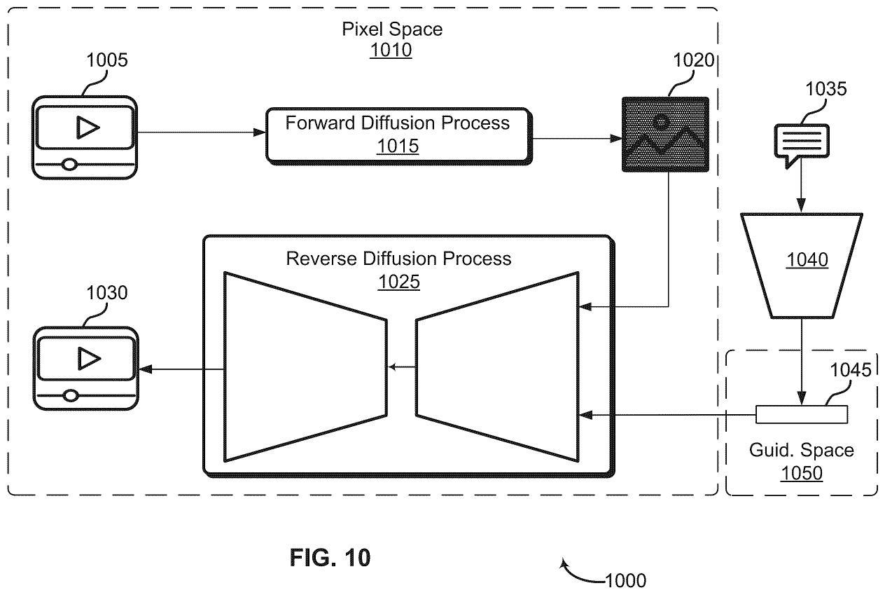

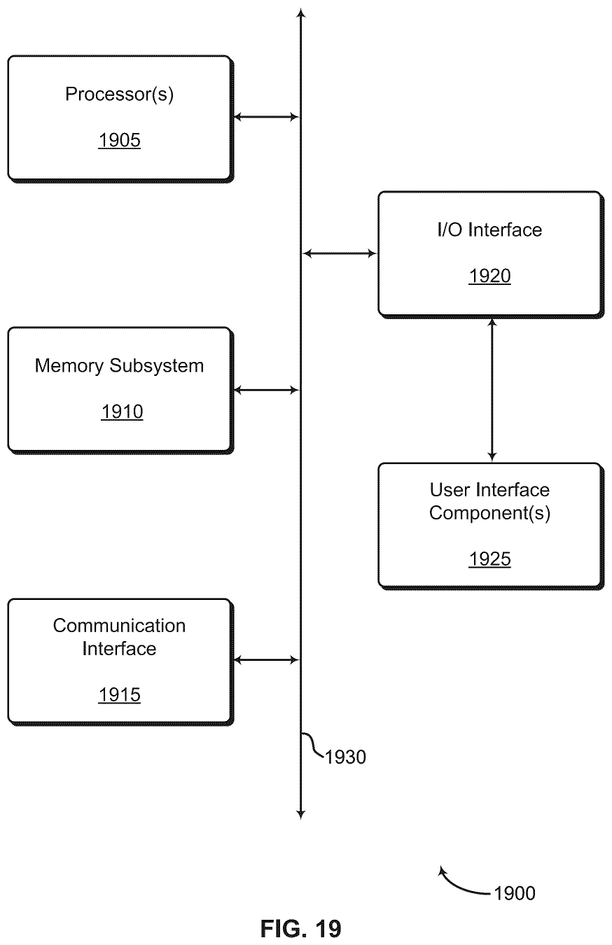

According to some aspects, image generation apparatus 105 includes a computer-implemented network. In some embodiments, the computer-implemented network includes a machine learning model (such as image generation model 110, described in further detail with reference to FIGS. 10-11 and 20). Image generation apparatus 105 may also include one or more processors, a memory subsystem, a communication interface, an I/O interface, one or more user interface components, and a bus as described with reference to FIG. 19. Additionally, image generation apparatus 105 may communicate with user device 135 and database 125 via cloud 120.

According to some aspects, image generation apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

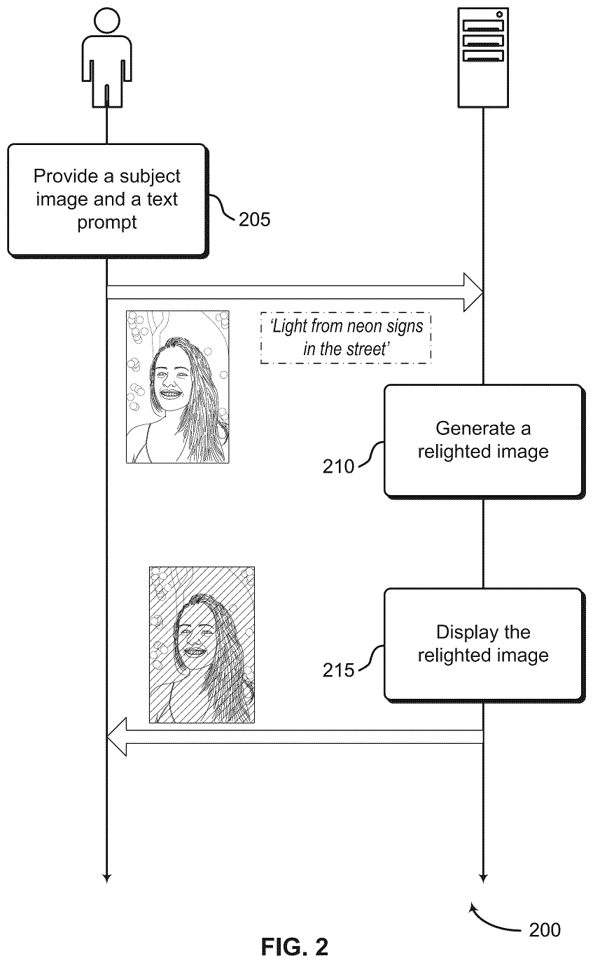

Further detail regarding the architecture of an image generation system is provided with reference to FIGS. 2-12 and 19-20. Further detail regarding an image generation process is provided with reference to FIGS. 2 and 13-15. Further detail regarding a process for training image generation model 110 is provided with reference to FIGS. 16-18.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between image generation apparatus 105, database 125, and user device 135.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in image generation apparatus 105. According to some aspects, database 125 is external to image generation apparatus 105 and communicates with image generation apparatus 105 via cloud 120.

According to some aspects, user device 135 is a personal computer, laptop computer, mainframe computer, palmtop computer, personal assistant, mobile device, or any other suitable processing apparatus. User device 135 may include software that displays user interface 115 (e.g., a graphical user interface) provided by image generation apparatus 105. The user interface 115 allows information (such as images, prompts, etc.) to be communicated between user 130 and image generation apparatus 105.

According to some aspects, a user device user interface enables user 130 to interact with user device 135. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

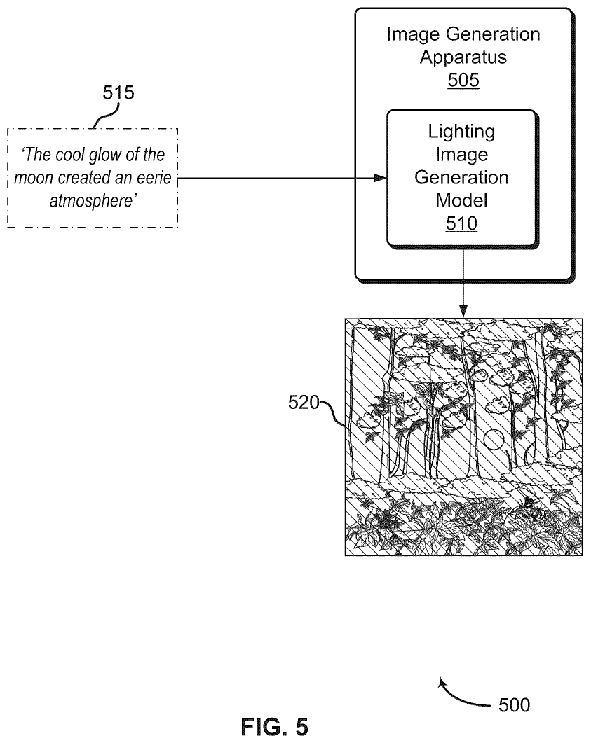

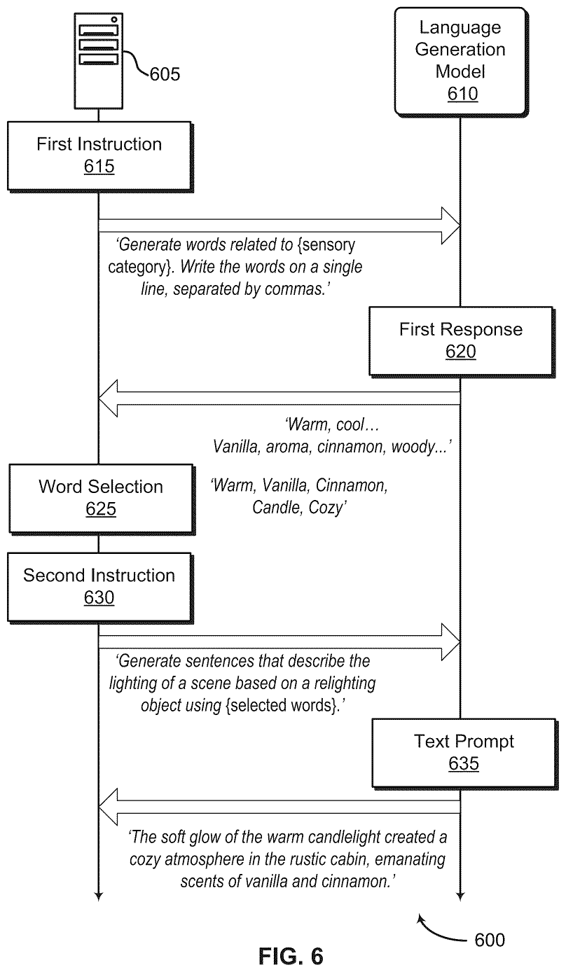

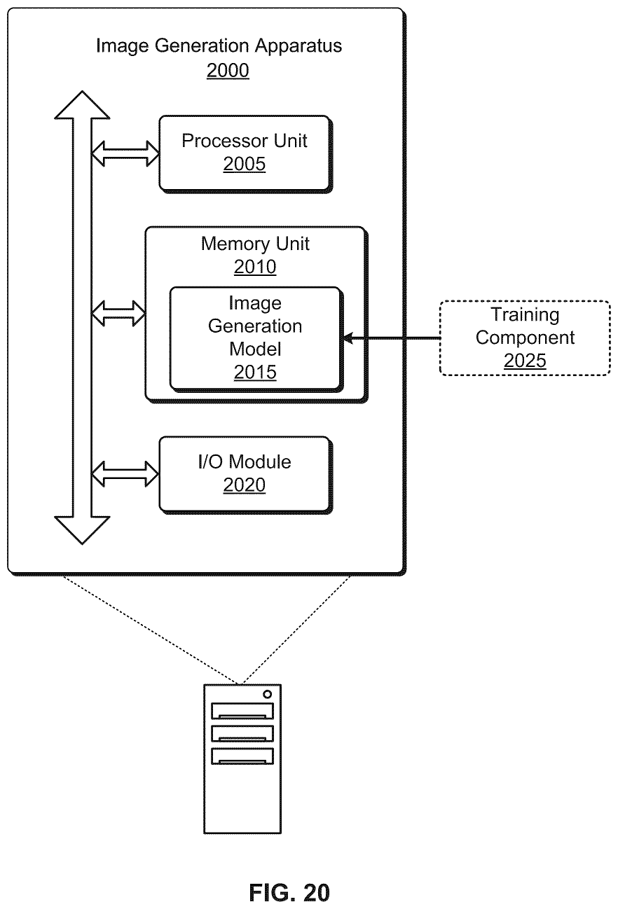

Image generation system 100 is an example of, or includes aspects of, the corresponding element described with reference to FIGS. 4-9. Image generation apparatus 105 is an example of, or includes aspects of, the corresponding element described with reference to FIGS. 4-9, and 20. Image generation model 110 is an example of, or includes aspects of, the corresponding element described with reference to FIG. 20. Text prompt 145 is an example of, or includes aspects of, the corresponding element described with reference to FIGS. 5 and 6. Relighted image 150 is an example of, or includes aspects of, the corresponding element described with reference to FIG. 4.

FIG. 2 shows an example of a method 200 for generating a relighted image according to aspects of the present disclosure. Referring to FIG. 2, according to some aspects, an image generation model (a lighting-specific foundational model) is provided that can perform relighting of an image driven by a text prompt, allowing a lighting space to be decomposed from a contents space. The model is trained based on a text prompt that describes a relighting object corresponding to a lighting condition.

Given a subject image, such as a portrait image depicting a person, aspects of the present disclosure control the lighting of the scene for both foreground and background driven by a text prompt, while ensuring that the original content and identity are preserved in the relighted image Ĩ=f_{θ}(I,M,T). θ denotes the learnable parameters and f is the text-guided relighting function that takes as input subject image I, foreground mask M, and text prompt T to generate the relighted image I. According to some aspects, to learn this mapping function, f is trained with the ground truth Ĩ_{gt} using a dataset including pairs of corresponding texts and relighted images that preserve a content and identity of source images as described with reference to FIGS. 16-18.

At operation 205, a user (such as the user described with reference to FIG. 1) provides a subject image and a text prompt. In an example, the user provides the subject image, depicting a foreground element and a background element, and the text prompt, describing a relighting object corresponding to a lighting condition (e.g., “Light from neon signs in the street”) to an image generation apparatus (such as the image generation apparatus described with reference to FIG. 1) via a user interface (such as the user interface described with reference to FIG. 1) displayed on a user device (such as the user device described with reference to FIG. 1) by the image generation apparatus.

At operation 210, the system generates a relighted image. In some cases, the operations of this step refer to, or may be performed by, an image generation apparatus as described with reference to FIGS. 1, 4-9, and 20. In some embodiments, the system generates the relighted image using an image generation process performed by an image generation model based on the subject image and the text prompt as described with reference to FIGS. 10, 14, and 15. Alternatively, in some embodiments, the image generation apparatus generates the relighted image using an image generation process based on separately relighting the foreground element and the background element as described with reference to FIG. 4. In some embodiments, the relighted image generated as described with reference to FIG. 4 is used as a ground-truth image to train the image generation model.

At operation 215, the system displays the relighted image. In some cases, the operations of this step refer to, or may be performed by, an image generation apparatus as described with reference to FIGS. 1, 4-9, and 20. For example, the user interface displays the relighted image on the user device.

Accordingly, some embodiments include obtaining a source image and a lighting input, wherein the lighting input indicates a lighting condition for the source image; generating, using an image generation model, a relighted foreground image and a relighted background image based on the source image and on the lighting input, wherein the relighted foreground image depicts a foreground element with the lighting condition and the relighted background image depicts a background element with the lighting condition; and combining the relighted foreground image and the relighted background image to obtain a relighted image, wherein the relighted image depicts the foreground element and the background element with the lighting condition

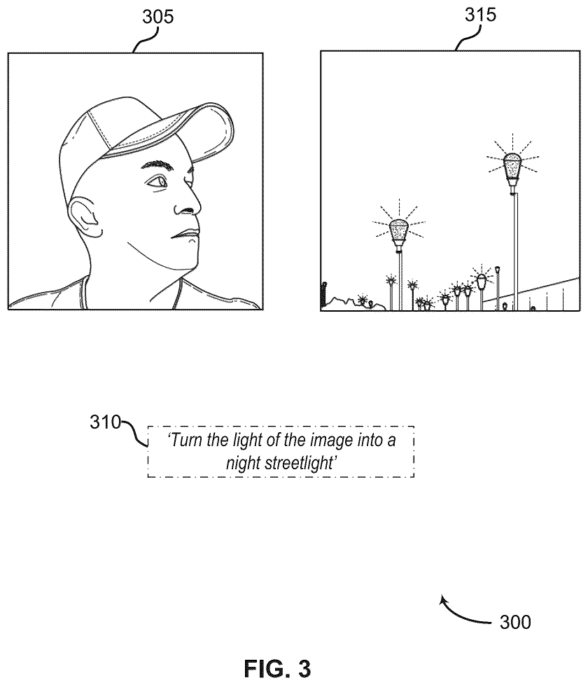

FIG. 3 shows an example 300 of a comparative generated image. The example shown includes comparative image 305, comparative text prompt 310, and comparative synthetic image 315. Referring to FIG. 3, comparative synthetic image 315 is generated based on comparative image 305 and comparative text prompt 310 by a diffusion model that is not trained based on a prompt describing a relighting object corresponding to a lighting condition. Accordingly, instead of relighting comparative image 305 according to comparative text prompt 310 to obtain comparative synthetic image 315, the untrained diffusion model generates unwanted new content for comparative synthetic image 315 (e.g., streetlights) based on comparative text prompt 310 and does not include wanted content from comparative image 305 (e.g., the person) in comparative synthetic image 315.

FIG. 4 shows an example of an image generation system 400 that generates a relighted image using a foreground image relighting process and a background image relighting process according to aspects of the present disclosure. The example shown includes image generation system 400, foreground image 420, background image 430, lighting image 440, relighted foreground image 445, relighted background image 450, relighted image 455, and source image 460.

In one aspect, image generation system 400 includes image generation apparatus 405. In one aspect, image generation apparatus 405 includes foreground image relighting model 410 and background image relighting model 415. In one aspect, foreground image 420 includes foreground element 425. In one aspect, background image 430 includes background element 435. In one aspect, relighted image 455 and source image 460 include foreground element 425 and background element 435. According to some aspects, each of foreground image relighting model 410 and background image relighting model 415 are comprised in an image generation model (such as the image generation model 2015 described with reference to FIG. 20).

FIG. 4 provides an overview of an example of a process for generating a relighted image. Referring to FIG. 4, according to some aspects, a foreground image relighting model (e.g., foreground image relighting model 410) generates a relighted foreground image (e.g., relighted foreground image 445) based on a foreground image (e.g., foreground image 420) and a lighting image (e.g., lighting image 440), a background image relighting model (e.g., background image relighting model 415) generates a relighted background image (e.g., relighted background image 450) based on a background image (e.g., background image 430) and the lighting image, and an image generation apparatus (e.g., image generation apparatus 405) generates a relighted image (e.g., relighted image 455) based on the relighted foreground image and the relighted background image. In some embodiments, the relighted image is an example of a ground-truth image used for training an image generation model as described with reference to FIG. 16.

The foreground image depicts a foreground element. The foreground image may omit content other than the foreground element. In some aspects, the foreground image is obtained by extracting a foreground element from a source image including the foreground element. Foreground image 420 depicts a person (foreground element 425) extracted from source image 460. In an example, the image generation apparatus detects the foreground element in the source image, generates a mask for the foreground element, and extracts the foreground element from the source image based on the mask (for example, using a masking algorithm or a masking machine learning model, such as a foreground mask detector comprising a U-Net with pyramid vision transformer). In some embodiments, the source image is an example of a source image used for training the image generation model as described with reference to FIG. 16. In some embodiments, the source image is an example of a subject image as described with reference to FIGS. 1, 3, and 14.

The lighting image depicts a lighting condition (depicted in lighting image 440 by diagonal hatching). In some aspects, the lighting image is generated based on a text prompt describing the lighting condition as described with reference to FIGS. 5, 10-11, and 13-14. In some aspects, the text prompt describing the lighting condition is generated as described with reference to FIGS. 6, 12, and 13. In some embodiments, the text prompt is an example of a text prompt as described with reference to FIG. 5. In some embodiments, the text prompt is an example of a text prompt used for training the image generation model as described with reference to FIG. 16. The lighting condition is an example of a lighting condition used for training the image generation model as described with reference to FIG. 16.

The background image depicts a background element. The background image may omit content other than the background element. In some aspects, the background image is obtained by extracting the background element from a source image including the background element. Background image 430 depicts a building interior (background element 435) extracted from source image 460. In an example, the image generation apparatus detects a foreground element in the source image, generates a mask for the foreground element, and extracts the background element from the source image based on the mask (for example, using a masking algorithm or the masking machine learning model). In some embodiments, the image generation apparatus in-fills a missing portion of the background image corresponding to the masked foreground element (for example, using an in-filling algorithm or an in-filling machine learning model, such as a diffusion model described with reference to FIG. 10). In some embodiments, the foreground element of the foreground image and the background element of the background image are extracted from a common source image.

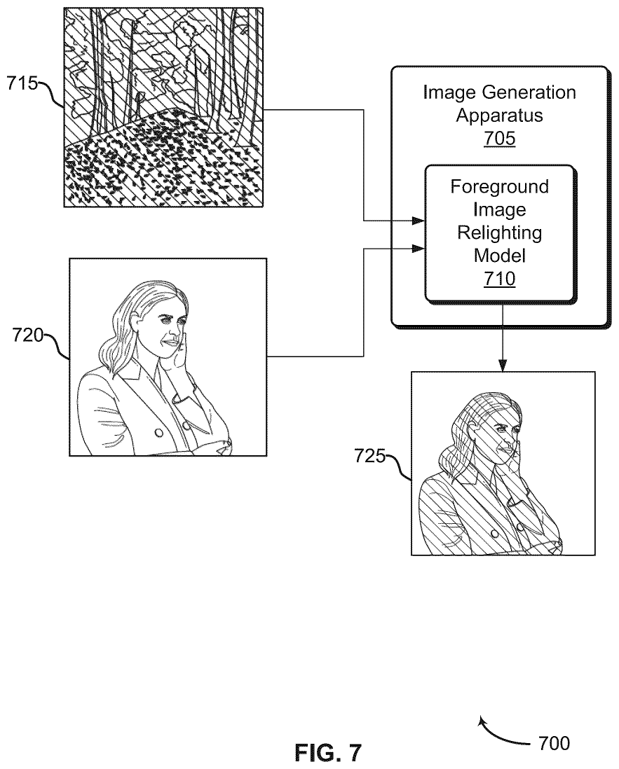

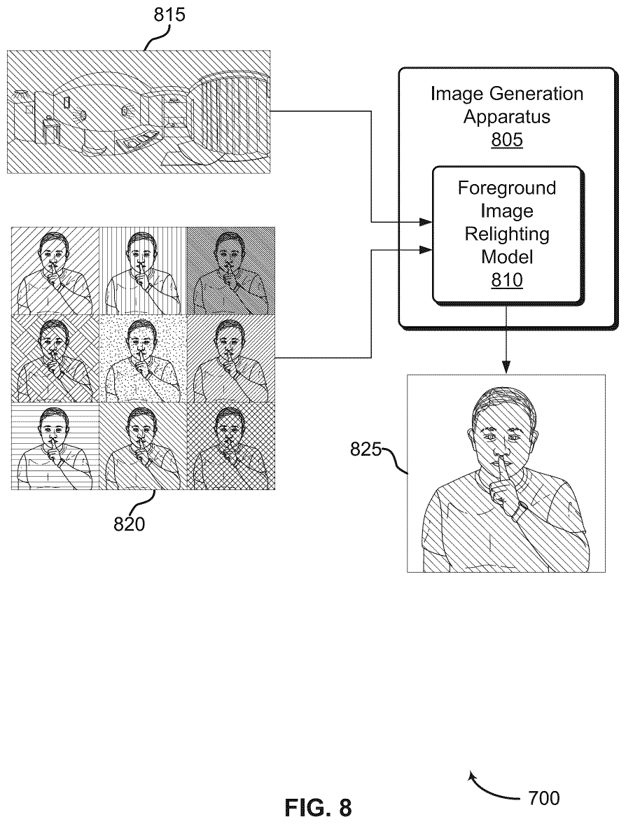

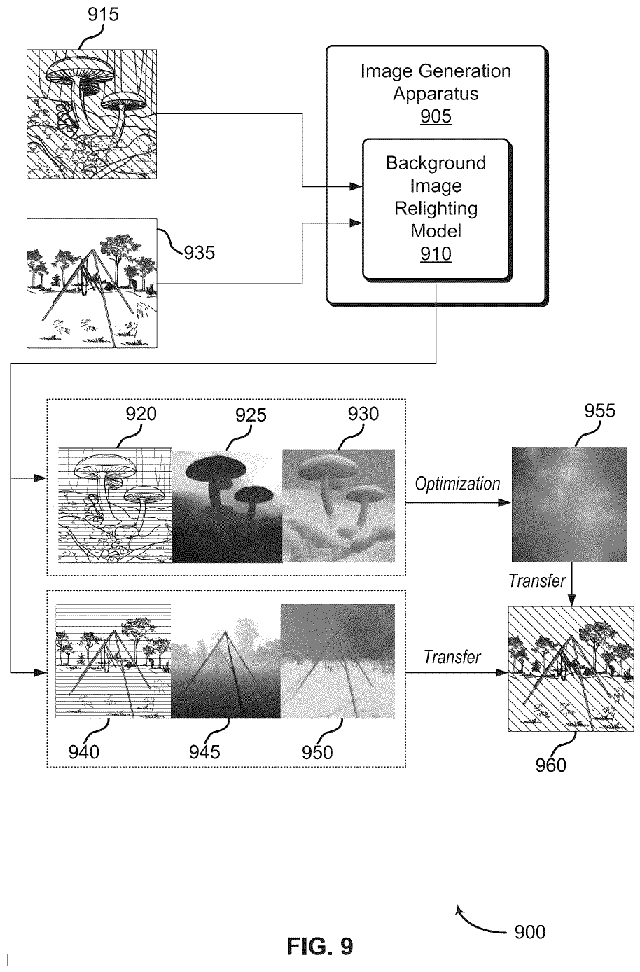

The relighted foreground image depicts the foreground element with the lighting condition. In some examples, the relighted foreground image omits content other than the foreground element. The relighted foreground image is described in further detail with reference to FIGS. 7-8. The relighted background image depicts the background element with the lighting condition. In some examples, the relighted background image omits content other than the background element. The relighted background image is described in further detail with reference to FIG. 9. The relighted image depicts the foreground element with the lighting condition and the background element with the lighting condition.

According to some aspects, the image generation apparatus combines the relighted foreground image and the relighted background image to obtain the relighted image. In some examples, the image generation apparatus extracts the foreground element from the relighted foreground image and inserts the extracted foreground element into or onto the relighted background image. In some examples, the image generation apparatus generates a mask for the foreground element included in the relighted foreground image. In some examples, the image generation apparatus combines the relighted foreground image and the relighted background image based on the mask. In some examples, the image generation apparatus superimposes the relighted foreground image on the relighted background image to obtain the relighted image. In some examples, the image generation apparatus generates the relighted image using an image generation model (such as the image generation model 2015 described with reference to FIG. 20) that takes the relighted foreground image, the relighted background image, and the mask for the foreground element as input.

Image generation system 400 is an example of, or includes aspects of, the corresponding element described with reference to FIGS. 1, and 5-9. Image generation apparatus 405 is an example of, or includes aspects of, the corresponding element described with reference to FIGS. 1, 5-9, and 20. Foreground image relighting model 410 is an example of, or includes aspects of, the corresponding element described with reference to FIGS. 7-8. Background image relighting model 415 is an example of, or includes aspects of, the corresponding element described with reference to FIG. 9.

Foreground image 420 is an example of, or includes aspects of, the corresponding element described with reference to FIGS. 7 and 8. Background image 430 is an example of, or includes aspects of, the corresponding element described with reference to FIG. 9. Lighting image 440 is an example of, or includes aspects of, the corresponding element described with reference to FIGS. 5, and 7-9. Relighted foreground image 445 is an example of, or includes aspects of, the corresponding element described with reference to FIGS. 7 and 8. Relighted background image 450 is an example of, or includes aspects of, the corresponding element described with reference to FIG. 9. Relighted image 455 is an example of, or includes aspects of, the corresponding element described with reference to FIG. 1.

FIG. 5 shows an example of an image generation system 500 that generates a lighting image according to aspects of the present disclosure. The example shown includes image generation system 500, lighting input 515, and lighting image 520. In one aspect, image generation system 500 includes image generation apparatus 505. In one aspect, image generation apparatus 505 includes lighting image generation model 510.

Referring to FIG. 5, according to some aspects, a lighting image generation model (e.g., lighting image generation model 510) generates a lighting image (e.g., lighting image 520) depicting a lighting condition (shown in FIG. 5 as diagonal hatching in lighting image 520) based on a text prompt (e.g., lighting input 515), where the text prompt describes the lighting condition. In the example of FIG. 5, lighting image 520 depicts a “cool glow of the moon created an eerie atmosphere” lighting condition described by lighting input 515. In some embodiments, the text prompt describes a relighting object corresponding to the lighting condition. In the example of FIG. 5, lighting input 515 describes a “moon” relighting object. According to some aspects, the text prompt is generated as described with reference to FIG. 6. According to some aspects, the text prompt is provided to image generation apparatus 505 by a user.

Image generation system 500 is an example of, or includes aspects of, the corresponding element described with reference to FIGS. 1, 4, and 6-9. Image generation apparatus 505 is an example of, or includes aspects of, the corresponding element described with reference to FIGS. 1, 4, 6-9, and 20.

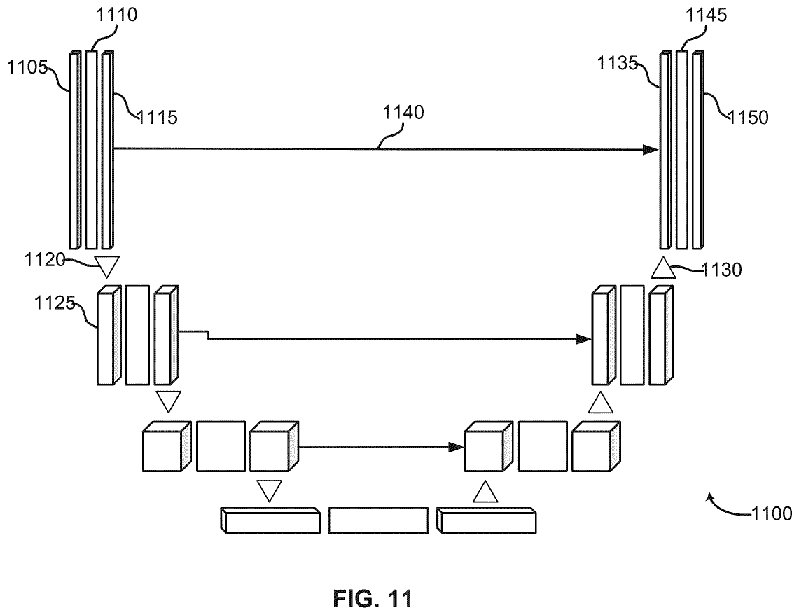

Lighting image generation model 510 comprises lighting image generation parameters (e.g., machine learning parameters) stored in the memory unit 2010 described with reference to FIG. 20. According to some aspects, lighting image generation model 510 comprises an artificial neural network (ANN) trained to generate the lighting image based on the text prompt. According to some aspects, lighting image generation model 510 comprises a diffusion model, such as the diffusion model described with reference to FIG. 10. In some embodiments, the image generation model 2015 described with reference to FIG. 20 is implemented as the lighting image generation model. In some embodiments, a U-Net such as the U-Net 1100 described with reference to FIG. 11 comprises architectural elements of lighting image generation model 510.

In some embodiments, lighting image generation model 510 comprises a latent consistency model trained to generate the lighting image using few diffusion steps (e.g., four diffusion steps). In some embodiments, lighting image generation model 510 comprises a text-guided panorama generation model. The text-guided panorama generation model comprises a pre-trained diffusion model (such as the diffusion model described with reference to FIG. 9) that is fine-tuned on panorama maps (such as high dynamic range (HDR) panorama maps) and paired text prompts to generate the lighting image as a panoramic image (e.g., an HDR panorama map) based on a text prompt.

Lighting input 515 is an example of, or includes aspects of, the corresponding element described with reference to FIG. 6. Lighting image 520 is an example of, or includes aspects of, the corresponding element described with reference to FIGS. 4, and 7-9.

FIG. 6 shows an example of an image generation system 600 that generates a lighting input according to aspects of the present disclosure. The example shown includes image generation system 600, first instruction 615, first response 620, word selection 625, second instruction 630, and lighting input 635. In one aspect, image generation system 600 includes image generation apparatus 605. In one aspect, image generation apparatus 605 includes language generation model 610.

Referring to FIG. 6, according to some aspects, image generation system 600 generates a text prompt that describes a scene in a context of lighting distribution using a large language generation model (e.g., language generation model 610). According to some aspects, image generation system 600 selects a few words from a predefined large vocabulary pool and provides the selected words as a constraint on the language generation model when instructing the language generation model to generate the text prompt. An example instruction including selected words is, “Could you describe the lighting property of a random scene using the words ‘cozy’ and ‘warm’?” By constraining the language generation model with the selected words, image generation system 600 allows the language generation model to generate diverse and creative text prompts.

According to some aspects, image generation system 600 uses a categorical hierarchy to define a large vocabulary pool. In one example, high-level categories related to lighting are pre-defined, and the language generation model 610 generates various sub-categories for each high-level category.

In an example, image generation apparatus 605 provides a first instruction to language generation model 610 to generate words relating to a sensory category. Examples of sensory categories include “atmosphere”, “color”, “temperature”, “directionality”, “emotion”, “intensity”, “light location”, “lighting effect”, “place”, “purpose of lighting”, “shape”, “smell”, “sound”, “source type”, “taste”, “time”, “touch”, “universe”, and “weather”. As shown in FIG. 6, first instruction 615 includes the text “Generate words related to ‘temperature’ or ‘smell’. Write the words on a single line, separated by commas.” The sensory categories are high-level categories.

Language generation model 610 generates words in response to the first instruction. As shown in FIG. 6, first response 620 includes “Warm, cool . . . [other words elided for ease of illustration]” relating to the “temperature” sensory category and “Vanilla, aroma, cinnamon, woody . . . ” relating to the “smell” sensory category. Each of the words in first response 620 is a sub-category.

Image generation apparatus 605 then selects one or more words provided by language generation model 610. In some embodiments, image generation apparatus 605 randomly selects the one or more words. In some embodiments, image generation apparatus 605 assigns higher weights during the selection to words that directly relate to a physical behavior of lighting, such as position and color, to help an image generation model that is trained on the text prompt (such as the image generation model 2015 described with reference to FIG. 20) to learn physical correctness during training.

Image generation apparatus 605 then provides a second instruction to language generation model 610 to generate sentences that describe a lighting condition (in some embodiments, according to a relighting object) using the selected words. In the example of FIG. 6, second instruction 630 includes the text “Generate sentences that describe the lighting of a scene based on a relighting object using ‘warm’, ‘vanilla’, ‘cinnamon’, ‘candle’, and ‘cozy’.

Language generation model 610 then generates the text prompt based on the second instruction. In the example of FIG. 6, lighting input 635 includes the text prompt “The soft glow of the warm candlelight created a cozy atmosphere in the rustic cabin, emanating scents of vanilla and cinnamon,” where the relighting object is the candle and “soft glow of the warm candlelight created a cozy atmosphere in the rustic cabin, emanating scents of vanilla and cinnamon” is the lighting condition.

According to some aspects, language generation model 610 further augments the text prompt by modifying words and/or structures within the text prompt while maintaining a length of the text prompt or by rephrasing the text prompt to generate an additional text prompt that includes fewer words than the text prompt.

Image generation system 600 is an example of, or includes aspects of, the corresponding element described with reference to FIGS. 1, 4, 5, and 7-9. Image generation apparatus 605 is an example of, or includes aspects of, the corresponding element described with reference to FIGS. 1, 4, 5, 7-9, and 20.

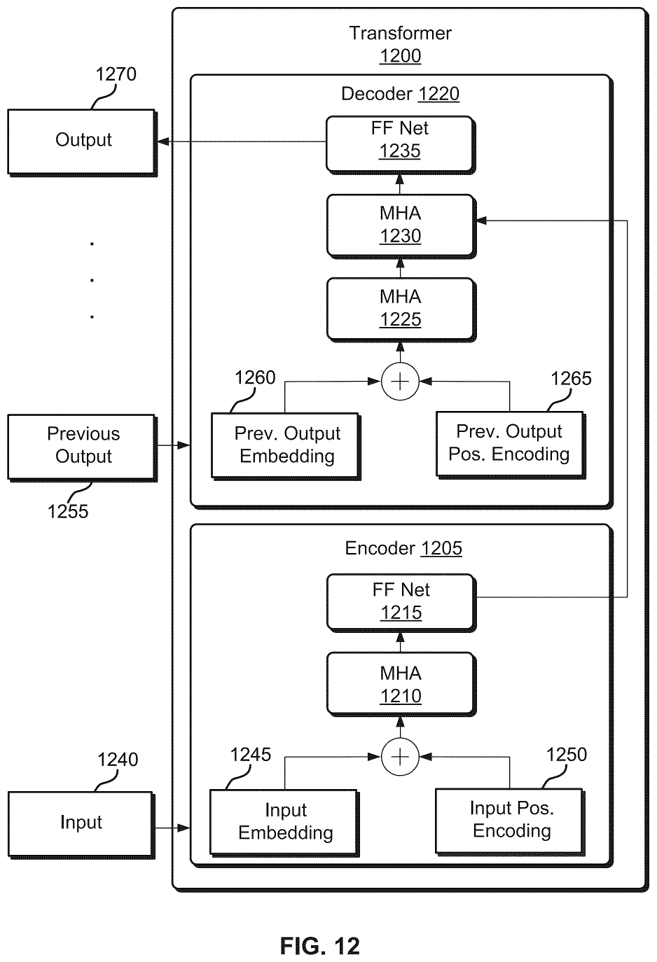

Language generation model 610 comprises text generation parameters (e.g., machine learning parameters) stored in the memory unit 2010 described with reference to FIG. 20. According to some aspects, language generation model 610 comprises an ANN trained to generate text in response to an instruction to generate the text. In some embodiments, language generation model 610 comprises a large language model (LLM) comprising one or more transformers, such as the transformer described with reference to FIG. 12. According to some aspects, language generation model 610 comprises an ANN trained to generate the text prompt based on a source image and a preliminary text prompt.

Lighting input 635 is an example of, or includes aspects of, the corresponding element described with reference to FIG. 5.

FIG. 7 shows an example of an image generation system 700 that employs a foreground image relighting method according to aspects of the present disclosure. The example shown includes image generation system 700, lighting image 715, foreground image 720, and relighted foreground image 725. In one aspect, image generation system 700 includes image generation apparatus 705. In one aspect, image generation apparatus 705 includes foreground image relighting model 710.

Referring to FIG. 7, according to some aspects, foreground image relighting model 710 generates a relighted foreground image (e.g., relighted foreground image 725) based on a foreground image (e.g., foreground image 720) and on a lighting image (e.g., lighting image 715), where the relighted foreground image depicts the foreground element (such as a person as shown in FIG. 7) with the lighting condition (shown in FIG. 7 using diagonal hatching). In an example, foreground image relighting model 710 obtains a noise map and denoises the noise map based on the foreground image and the lighting image to obtain the relighted foreground image.

According to some aspects, foreground image relighting model 710 obtains a noise map. In some examples, foreground image relighting model 710 denoises the noise map based on the foreground image 720 and the lighting image 715 to obtain a relighted foreground image 725, where the ground-truth image is obtained based on the relighted foreground image 725. According to some aspects, foreground image relighting model 710 concatenates a latent foreground image and a mask for the foreground element with the noise map for a U-Net denoiser and conditions the lighting image through ControlNet.

ControlNet is an ANN structure that controls image generation models by adding extra conditions. In some embodiments, a ControlNet architecture copies the weights from one or more blocks of the image generation model to create a “locked” copy and a “trainable” copy of the image generation model, where the trainable copy learns a condition and the locked copy preserves parameters of the original image generation model. The trainable copy can be tuned with a small dataset of image pairs, while the locked copy ensures that the original image generation model is preserved.

Image generation system 700 is an example of, or includes aspects of, the corresponding element described with reference to FIGS. 1, 4-6, 8, and 9. Image generation apparatus 705 is an example of, or includes aspects of, the corresponding element described with reference to FIGS. 1, 4-6, 8, 9, and 20. Foreground image relighting model 710 is an example of, or includes aspects of, the corresponding element described with reference to FIGS. 4 and 8.

According to some aspects, foreground image relighting model 710 comprises foreground relighting parameters (e.g., machine learning parameters) stored in the memory unit 2010 described with reference to FIG. 20. According to some aspects, foreground image relighting model 710 comprises an ANN trained to generate the relighted foreground image based on the lighting image and the foreground image. In some embodiments, a U-Net such as the U-Net 1100 described with reference to FIG. 11 comprises architectural elements of foreground image relighting model 710. According to some aspects, foreground image relighting model 710 comprises a diffusion model, such as the diffusion model described with reference to FIG. 10.

In some embodiments, foreground image relighting model 710 is fine-tuned using relighting data including a same foreground image under different lighting conditions. In some embodiments, the relighting data is captured from a light stage. A light stage is an active illumination system used for shape, texture, reflectance and motion capture using structured light and a multi-camera setup.

Lighting image 715 is an example of, or includes aspects of, the corresponding element described with reference to FIGS. 4, 5, 8, and 9. Foreground image 720 and relighted foreground image 725 are examples of, or include aspects of, the corresponding elements described with reference to FIGS. 4 and 8.

FIG. 8 shows an example of an image generation system 800 that employs a foreground image relighting method based on a panoramic image according to aspects of the present disclosure. The example shown includes image generation system 800, lighting image 815, foreground image 820, and relighted foreground image 825. In one aspect, image generation system 800 includes image generation apparatus 805. In one aspect, image generation apparatus 805 includes foreground image relighting model 810.

Referring to FIG. 8, according to some aspects, foreground image relighting model 810 receives a set of one light at a time (OlAT) images as a foreground image (e.g., foreground image 820). OLAT images are captured using a light stage and include different lighting conditions (as shown in FIG. 8 by various hatching applied to foreground image 820) applied to a same foreground element (as shown in FIG. 8, a person). In some embodiments, given a set of OLAT images as the foreground image, foreground image relighting model 810 uses a panoramic image as described with reference to FIG. 5 as a lighting image (e.g., lighting image 815). Foreground image relighting model 810 generates a relighted foreground image (e.g., relighted foreground image 825) based on lighting image 815 and foreground image 820.

Image generation system 800 is an example of, or includes aspects of, the corresponding element described with reference to FIGS. 1, 4-7, and 9. Image generation apparatus 805 is an example of, or includes aspects of, the corresponding element described with reference to FIGS. 1, 4-7, 9, and 20. Foreground image relighting model 810 is an example of, or includes aspects of, the corresponding element described with reference to FIGS. 4 and 7.

According to some aspects, foreground image relighting model 810 comprises foreground relighting parameters (e.g., machine learning parameters) stored in the memory unit 2010 described with reference to FIG. 20. According to some aspects, foreground image relighting model 810 comprises an ANN trained to generate the relighted foreground image based on the lighting image and the foreground image. In some embodiments, a U-Net such as the U-Net 1100 described with reference to FIG. 11 comprises architectural elements of foreground image relighting model 810. According to some aspects, foreground image relighting model 810 comprises an encoder that encodes the foreground image and a decoder that decodes the encoded foreground image based on the lighting image to obtain the relighted foreground image.

Lighting image 815 is an example of, or includes aspects of, the corresponding element described with reference to FIGS. 4, 5, 7, and 9. Foreground image 820 and relighted foreground image 825 are examples of, or include aspects of, the corresponding elements described with reference to FIGS. 4 and 7.

FIG. 9 shows an example of an image generation system 900 that employs a background image relighting method according to aspects of the present disclosure. The example shown includes image generation system 900, lighting image 915, background image 935, reconstructed lighting image 955, and relighted background image 960. In one aspect, image generation system 900 includes image generation apparatus 905. In one aspect, image generation apparatus 905 includes background image relighting model 910. In one aspect, lighting image 915 includes lighting image albedo 920, lighting image depth 925, and lighting image surface normal 930. In one aspect, background image 935 includes background image albedo 940, background image depth 945, and background image surface normal 950.

Referring to FIG. 9, an image may be represented as multiple layers of intrinsic values: I=A*S where I, A, and S represent the image, an albedo of the image, and a shading map of the image, respectively. Furthermore, the shading can be described as a function of geometry and lighting: S=s(L,G), where s is a rendering function that outputs the shading map S as a function of input lighting information L and geometry G, which is often composed of depth D and surface normal N: G→{D, N}. Assuming L is under the definition of a point lighting, or illumination of an object from one or more point lights at different coordinates, the shading map S can be described as a function of multiple light sources:

$$S = {\sum }_{i = 1}^{n} {S}_{i} = {\sum }_{i = 1}^{n} s ( {L}_{i} , \{ D , N \} ) \qquad ( 1 )$$

In Eq. 1, each Sᵢ corresponds to a shading contribution from an individual light Lᵢ and n represents a number of point lights. As the lighting L is completely decomposed from other intrinsic values, it is possible to transfer a lighting distribution from one image to another image:

$$= \hat{A} * \tilde{S} = \hat{A} * {\sum }_{i = 1}^{n} s ( {L}_{i} , \{ \hat{D} , \hat{N} \} ) \qquad ( 2 )$$

In Eq. 2, Â, \hat{D}, and Ñ are an albedo, a depth, and a normal of a background image I_{B} (e.g., background image 935) (e.g., background image albedo 940, background image depth 945, and background image surface normal 950, respectively), [symbol] is a relighted background image (e.g., relighted background image 960), \tilde{S} is a shading map of the relighted background image, and Lᵢ is lighting information from a lighting image (e.g., lighting image 915, where the lighting information is depicted using diagonal hatching). Background image relighting model 910 may extract Â, \hat{D}, and \hat{N} from the background image.

According to some aspects, given a lighting image I_{light}, background image relighting model 910 reconstructs point lights (e.g., reconstructed lighting image 955) by optimizing the objective of Eq. 3:

$$ℒ = {‖ {I}_{l ight} - A * {\sum }_{i = 1}^{n} s ( {L}_{i} , \{ D , N \} ) ‖}_{2}^{2} \qquad ( 3 )$$

Background image relighting model 910 may extract the albedo A, the normal N, and the depth D from the lighting image I_{llight} (e.g., lighting image albedo 920, lighting image depth 925, and lighting image surface normal 930, respectively). Each point light L is composed of a set of learnable parameters including color C, 3D position P=(x_{L},y_{L},z_{L}), intensity [symbol] , ellipsoid ratio ε, and a diffuse parameter σ. By taking the learnable parameters, a differentiable rendering function s performed by background image relighting model 910 renders the shading at each pixel position {x, y} under Lambertian reflectance:

$$s ( L , \{ D , N \} , \{ x , y \} ) = C \cdot [ 𝒥 \cdot N ( x , y ) \cdot l ( x , y , D ( x , y ) ; P , ε , σ ) ] \qquad ( 4 )$$

In Eq. 4,

$$l ( x , y , z ; P , ε , σ ) = \frac{( {x}_{L} - x , ε \cdot ( {y}_{L} - y ) , {z}_{L} - z )}{{( \sqrt{{( ( {x}_{L} - x ) )}^{2} + {( {y}_{L} - y )}^{2} + {( {z}_{L} - z )}^{2}} )}^{σ}} \qquad ( 5 )$$

Also, in Eq. 4, N(x, y) and D(x, y)=z represent the surface normal and the depth at pixel position {x, y} of the lighting image I_{light}, respectively.

According to some aspects, background image relighting model 910 allocates one or more (e.g., 20) point lights within a normalized 3D cube, where initial positions of the one or more point lights are configured using a distance-based selection algorithm that maximizes the minimum distance between the one or more point lights that correspond to strong pixel intensity, thereby localizing 3D point lights around pixels having strong intensity while they spread each other. In some embodiments, background image relighting model 910 initializes a depth of each point light using D(x, y). In some embodiments, background image relighting model 910 initializes a color as (0.5, 0.5, 0.5), an intensity as

$$\frac{1}{\# of lights} ,$$

an ellipsoid ratio as 1, and a diffuse parameter as 1.

According to some aspects, background image relighting model 910 transfers the reconstructed point lights to the background image according to Eq. 2 to generate the relighted background image. In some embodiments, background image relighting model 910 transfers a relative distance between the scene (i.e., depth) and lighting position while keeping same values for the other parameters.

Image generation system 900 is an example of, or includes aspects of, the corresponding element described with reference to FIGS. 1, and 4-8. Image generation apparatus 905 is an example of, or includes aspects of, the corresponding element described with reference to FIGS. 1, 4-8, and 20. Background image relighting model 910 is an example of, or includes aspects of, the corresponding element described with reference to FIG. 4. According to some aspects, background image relighting model 910 comprises parameters stored in the memory unit 2010 described with reference to FIG. 20. In some embodiments, a U-Net such as the U-Net 1100 described with reference to FIG. 11 comprises architectural elements of background image relighting model 910. In some embodiments, background image relighting model 910 detects a normal and/or a depth from an image using a U-Net with pyramid vision transformer.

Lighting image 915 is an example of, or includes aspects of, the corresponding element described with reference to FIGS. 4, 5, 7, and 8. According to some aspects, the lighting image comprises a centered crop of a panoramic image. Background image 935 and relighted background image 960 are examples of, or include aspects of, the corresponding elements described with reference to FIG. 4.

FIG. 10 shows an example of a guided diffusion model 1000 according to aspects of the present disclosure. In some examples, guided diffusion model 1000 describes the operation and architecture of the image generation model 2015 described with reference to FIG. 20.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, during training, guided diffusion model 1000 may take an original image 1005 in a pixel space 1010 as input and apply forward diffusion process 1015 to gradually add noise to the original image 1005 to obtain noisy images 1020 at various noise levels.

Next, a reverse diffusion process 1025 (e.g., a U-Net) gradually removes the noise from the noisy images 1020 at the various noise levels to obtain an output image 1030. In some cases, an output image 1030 is created from each of the various noise levels. The output image 1030 can be compared to the original image 1005 to train the reverse diffusion process 1025.

The reverse diffusion process 1025 can also be guided based on a text prompt 1035, or another guidance prompt, such as an image, a layout, a segmentation map, etc. The text prompt 1035 can be encoded using a text encoder 1040 (e.g., a multimodal encoder) to obtain guidance features 1045 in guidance space 1050. The guidance features 1045 can be combined with the noisy images 1020 at one or more layers of the reverse diffusion process 1025 to ensure that the output image 1030 includes content described by the text prompt 1035. For example, guidance features 1045 can be combined with the noisy features using a cross-attention block within the reverse diffusion process 1025.

Cross-attention, also known as multi-head attention, is an extension of the attention mechanism. In some cases, cross-attention enables reverse diffusion process 1025 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 1025 to better understand the context and generate more accurate and contextually relevant outputs.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image. In some embodiments, guided diffusion model 1000 is implemented as a guided latent diffusion model.

FIG. 11 shows an example of a U-Net 1100 according to aspects of the present disclosure. In some examples, U-Net 1100 is an example of the component that performs the reverse diffusion process 1025 of guided diffusion model 1000 described with reference to FIG. 10, and includes architectural elements of the image generation model 2015 described with reference to FIG. 20. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input features 1105 having an initial resolution and an initial number of channels, and processes the input features 1105 using an initial neural network layer 1110 (e.g., a convolutional network layer) to produce intermediate features 1115. The intermediate features 1115 are then down-sampled using a down-sampling layer 1120 such that down-sampled features 1125 features have a resolution less than the initial resolution and a number of channels greater than the initial number of channels.

This process is repeated multiple times, and then the process is reversed. That is, the down-sampled features 1125 are up-sampled using up-sampling process 1130 to obtain up-sampled features 1135. The up-sampled features 1135 can be combined with intermediate features 1115 having a same resolution and number of channels via a skip connection 1140. These inputs are processed using a final neural network layer 1145 to produce output features 1150. In some cases, the output features 1150 have the same resolution as the initial resolution and the same number of channels as the initial number of channels.

In some cases, U-Net 1100 takes additional input features to produce conditionally generated output. For example, the additional input features could include a vector representation of an input prompt. The additional input features can be combined with the intermediate features 1115 within the neural network at one or more layers. For example, a cross-attention module can be used to combine the additional input features and the intermediate features 1115.

FIG. 12 shows an example of a transformer 1200 according to aspects of the present disclosure. The example shown includes encoder 1205, decoder 1220, input 1240, input embedding 1245, input positional encoding 1250, previous output 1255, previous output embedding 1260, previous output positional encoding 1265, and output 1270. According to some aspects, transformer 1200 comprises architectural elements of the language generation model 610 described with reference to FIG. 6.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Encoder 1205 includes multi-head self-attention sublayer 1210 and feed-forward network sublayer 1215. Decoder 1220 includes first multi-head self-attention sublayer 1225, second multi-head self-attention sublayer 1230, and feed-forward network sublayer 1235.

Encoder 1205 is configured to map input 1240 (for example, an instruction) to a sequence of continuous representations that are fed into decoder 1220. Decoder 1220 generates output 1270 (e.g., a prediction of an output sequence of words or tokens) based on the output of encoder 1205 and previous output 1255 (e.g., a previously predicted output sequence), which allows for the use of autoregression.

For example, encoder 1205 parses input 1240 into tokens and vectorizes the parsed tokens to obtain input embedding 1245, and adds input positional encoding 1250 (e.g., positional encoding vectors for input 1240 of a same dimension as input embedding 1245) to input embedding 1245. Input positional encoding 1250 includes information about relative positions of words or tokens in input 1240.

Encoder 1205 comprises one or more encoding layers that generate contextualized token representations, where each representation corresponds to a token that combines information from other input tokens via self-attention mechanism. Each encoding layer of encoder 1205 comprises a multi-head self-attention sublayer (e.g., multi-head self-attention sublayer 1210). The multi-head self-attention sublayer implements a multi-head self-attention mechanism that receives different linearly projected versions of queries, keys, and values to produce outputs in parallel. Each encoding layer of encoder 1205 also includes a fully connected feed-forward network sublayer (e.g., feed-forward network sublayer 1215) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 6 )$$

Each layer employs different weight parameters (W₁, W₂) and different bias parameters (b₁, b₂) to apply a same linear transformation to each word or token in input 540.

Each sublayer of encoder 1205 is followed by a normalization layer that normalizes a sum computed between a sublayer input x and an output sublayer (x) generated by the sublayer:

$$layernorm ( x + sublayer ( x ) ) \qquad ( 7 )$$

Encoder 1205 is bidirectional because encoder 1205 attends to each word or token in input 1240 regardless of a position of the word or token in input 1240.

Decoder 1220 comprises one or more decoding layers (e.g., six decoding layers). Each decoding layer comprises three sublayers including a first multi-head self-attention sublayer (e.g., first multi-head self-attention sublayer 1225), a second multi-head self-attention sublayer (e.g., second multi-head self-attention sublayer 1230), and a feed-forward network sublayer (e.g., feed-forward network sublayer 1235). Each sublayer of decoder 1220 is followed by a normalization layer that normalizes a sum computed between a sublayer input x and an output sublayer (x) generated by the sublayer.

Decoder 1220 generates previous output embedding 1260 of previous output 1255 and adds previous output positional encoding 1265 (e.g., position information for words or tokens in previous output 1255) to previous output embedding 1260. Each first multi-head self-attention sublayer receives the combination of previous output embedding 1260 and previous output positional encoding 1265 and applies a multi-head self-attention mechanism to the combination. For each word in an input sequence, each first multi-head self-attention sublayer of decoder 1220 attends only to words preceding the word in the sequence, and so a prediction of transformer 1200 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 1205 by receiving a query Q from a previous sublayer of decoder 1220 and a key K and a value V from the output of encoder 1205, allowing decoder 1220 to attend to each word in the input 1240.

Each feed-forward network sublayer implements a fully connected feed-forward network similar to feed-forward network sublayer 1215. The feed-forward network sublayers are followed by a linear transformation and a softmax to generate a prediction of output 1270.

### Image Generation

FIG. 13 shows an example of a method 1300 for generating a relighted image based on a lighting image according to aspects of the present disclosure. Referring to FIG. 13, according to some aspects, an image generation system (such as the image generation system described with reference to FIG. 13) generates a relighted image by applying a lighting condition from a lighting image to a foreground element, applying the lighting condition to a background element, and combining the foreground element with the background element to obtain the relighted image. In some embodiments, the image-based relighting is performed differently for background and foreground based on factors including data availability, algorithm maturity, and scene complexity, thereby providing a more accurate relighted image.

The lighting condition may be indicated by a lighting input (e.g., a text prompt) that is used to generate the lighting image. The lighting condition may be expressed according to a relighting object described in the lighting input. In some embodiments, the relighted image may be used as a ground-truth image to train an image generation model to generate an additional relighted image based on a subject image and a text prompt as described with reference to FIG. 16.

At operation 1305, the system obtains a source image and a lighting input, where lighting input indicates a lighting condition for the source image. In some cases, the operations of this step refer to, or may be performed by, an image generation apparatus as described with reference to FIGS. 1, 4-9, and 20.

In some embodiments, the image generation apparatus retrieves one or more of the source image and the lighting input from a database, such as the database 125 described with reference to FIG. 1. In some embodiments, a user, such as the user 130 described with reference to FIG. 1, provides one or more of the source image and the lighting input to the image generation apparatus. In some embodiments, the image generation apparatus extracts one or more of a foreground image and a background image from the source image. The foreground image is described in further detail with reference to FIGS. 4 and 7-8. The background image is described in further detail with reference to FIGS. 4 and 9. The source image is described in further detail with reference to FIG. 4.

In some embodiments, the image generation apparatus generates the lighting image using a lighting image generation model. In some embodiments, the image generation apparatus generates the lighting image based on the lighting input (e.g., a text prompt describing a lighting condition). In some embodiments, the image generation apparatus generates the lighting input using a language generation model. The lighting image is described in further detail with reference to FIGS. 4, 5, and 7-9. The lighting input is described in further detail with reference to FIG. 6.

At operation 1310, the system generates, using an image generation model, a relighted foreground image and a relighted background image based on the source image and on the lighting input, where the relighted foreground image depicts a foreground element with the lighting condition and the relighted background image depicts a background element with the lighting condition. In some cases, the operations of this step refer to, or may be performed by, a an image generation model as described with reference to FIGS. 1 and 20.

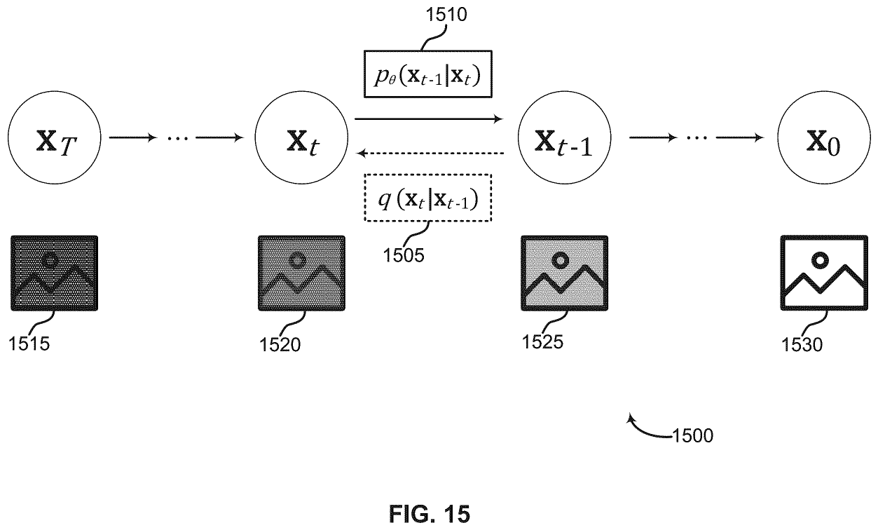

In some embodiments, generating the relighted foreground image comprises obtaining a noise map and denoising the noise map based on the foreground image and a lighting image generated based on the lighting input using a diffusion process performed by a foreground relighting model of the image generation model as described with reference to FIGS. 10 and 15. The generation of the relighted foreground image by the foreground image relighting model is described in further detail with reference to FIGS. 4 and 7-8.

In some embodiments, generating the relighted background image comprises extracting albedo information, depth information, and surface normal information from the lighting image, and transferring the lighting condition from the lighting image to the background image based on the albedo information, the depth information, and the surface normal information by a background image relighting model of the image generation model as described with reference to FIGS. 4 and 9. In some embodiments, generating the relighted background image comprises identifying a plurality of point lights from the lighting image and transferring the lighting condition from the plurality of point lights to the background image based on the albedo information, the depth information, and the surface normal information as described with reference to FIG. 9. The relighted background image is described in further detail with reference to FIGS. 4 and 9.

At operation 1315, the system combines the relighted foreground image and the relighted background image to obtain a relighted image, where the relighted image depicts the foreground element and the background element with the lighting condition. In some cases, the operations of this step refer to, or may be performed by, an image generation apparatus as described with reference to FIGS. 1, 4-9, and 20.

In some examples, the image generation apparatus extracts the foreground element from the relighted foreground image and inserts the extracted foreground element into or onto the relighted background image. In some examples, the image generation apparatus generates a mask for the foreground element included in the relighted foreground image. In some examples, the image generation apparatus combines the relighted foreground image and the relighted background image based on the mask. In some examples, the image generation apparatus superimposes the relighted foreground image on the relighted background image to obtain the relighted image. In some examples, the image generation apparatus generates the relighted image using an image generation model (such as the image generation model 2015 described with reference to FIG. 20) that takes the relighted foreground image, the relighted background image, and the mask for the foreground element as input. The relighted image is described in further detail with reference to FIG. 4.

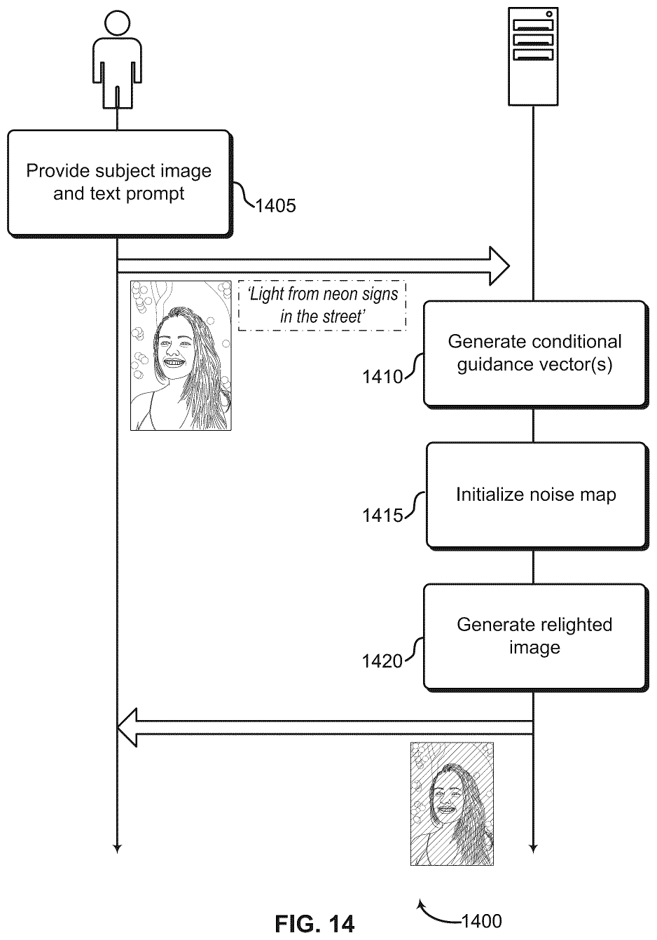

FIG. 14 shows an example of a method 1400 for generating a relighted image using a diffusion process according to aspects of the present disclosure. In some examples, method 1400 describes an operation of the image generation model 2015 described with reference to FIG. 20 such as an application of the guided diffusion model 1000 described with reference to FIG. 10. In some examples, these operations are performed by a system including a processor executing a set of codes to control functional elements of an apparatus such as the image generation model described in FIG. 10.

Additionally or alternatively, steps of the method 1400 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 14, according to some aspects, an image generation model that is trained according to the process described with reference to FIGS. 16-18 is used to generate a relighted image based on a subject image and a text prompt describing a lighting condition. In some embodiments, the image generation model is trained based on a training dataset including a source image, a text prompt, and a ground-truth image, where the ground-truth image is a relighted image generated as described with reference to FIGS. 4 and 13.

At operation 1405, a user provides a subject image depicting content to be included in a generated image and a text prompt describing a lighting condition to be included in the generated image. For example, a user may provide the prompt “light from neon signs in the street”. In some examples, guidance can be provided in a form other than text, such as via an image, a sketch, or a layout.

At operation 1410, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1415, a noise map is initialized that includes random noise. The noise map may be in a pixel space or a latent space. By initializing an image with random noise, different variations of an image including the content described by the subject image with the lighting condition described by the conditional guidance can be generated.

At operation 1420, the system generates an image based on the noise map, the subject image, and the conditional guidance vector. For example, the image may be generated using a reverse diffusion process as described with reference to FIG. 15.

FIG. 15 shows an example of a diffusion process 1500 according to aspects of the present disclosure. In some examples, diffusion process 1500 describes an operation of the image generation model 2015 described with reference to FIG. 20, such as the reverse diffusion process 1025 of guided diffusion model 1000 described with reference to FIG. 10. In some examples, diffusion process 1500 describes an operation of the foreground image relighting model 410 described with reference to FIG. 4, such as the reverse diffusion process 1025 of guided diffusion model 1000 described with reference to FIG. 10. In some examples, diffusion process 1500 describes an operation of the lighting image generation model 510 described with reference to FIG. 5, such as the reverse diffusion process 1025 of guided diffusion model 1000 described with reference to FIG. 10.

As described above with reference to FIG. 10, using a diffusion model can involve both a forward diffusion process 1505 for adding noise to an image (or features in a latent space) and a reverse diffusion process 1510 for denoising the images (or features) to obtain a denoised image. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate images with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x_{T}, such as a noisy image 1515, and denoises the data to obtain the p(xₜ₋₁|xₜ). At each step t−1, the reverse diffusion process 1510 takes xₜ, such as first intermediate image 1520, and t as input. Here, t represents a step in the sequence of transitions associated with different noise levels, The reverse diffusion process 1510 outputs xₜ₋₁, such as second intermediate image 1525 iteratively until x_{T} reverts back to x₀, the original image 1530. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 8 )$$

The joint probability of a sequence of samples in the Markov chain can be written as a product of conditionals and the marginal probability:

$${x}_{T} : {p}_{θ} ( {x}_{0 : τ} ) := p ( {x}_{T} ) {\prod }_{t = 1}^{T} {p}_{θ} ( {x}_{t - 1} \vert {x}_{t} ) , \qquad ( 9 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Accordingly, a method for image generation is described. One or more aspects of the method include obtaining a source image and a lighting input, wherein the lighting input indicates a lighting condition for the source image; generating, using an image generation model, a relighted foreground image and a relighted background image based on the source image and on the lighting input, wherein the relighted foreground image depicts a foreground element with the lighting condition and the relighted background image depicts a background element with the lighting condition; and combining the relighted foreground image and the relighted background image to obtain a relighted image, wherein the relighted image depicts the foreground element and the background element with the lighting condition.

Some examples of the method further include extracting a foreground image and a background image from the source image, wherein the relighted foreground image is based on the foreground image and the relighted background image is based on the background image. In some aspects, the foreground image depicts a plurality of versions of the foreground element under different lighting conditions and the lighting image comprises a panoramic image.

Some examples of the method further include generating a lighting image based on the lighting input, wherein the relighted foreground image is based on the lighting image. Some examples of the method further include identifying a sensory category. Some examples further include selecting a word based on the sensory category. Some examples further include generating the lighting input to include the selected word. Some examples of the method further include obtaining a noise map. Some examples further include denoising the noise map based on the lighting input.

Some examples of the method further include determining albedo information, depth information, and surface normal information based on the lighting input. Some examples further include transferring the lighting condition from the lighting image to the background image based on the albedo information, the depth information, and the surface normal information.

Some examples of the method further include identifying a plurality of point lights based on the lighting input. Some examples further include transferring the lighting condition from the plurality of point lights to the background image based on the albedo information, the depth information, and the surface normal information. Some examples of the method further include creating a dataset including the relighted image. Some examples further include training an image generation model using the dataset.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 16 shows an example of a method 1600 for training an image generation model according to aspects of the present disclosure. Referring to FIG. 16, the image generation model (such as the image generation model 2015 described with reference to FIG. 20) is trained to generate a relighted image depicting a scene with a lighting condition. In some embodiments, the scene is depicted in a subject image and the lighting condition is described by a text prompt.

At operation 1605, the system obtains a training set including a source image, a text prompt, and a ground-truth image, where the source image depicts a scene, the text prompt describes a relighting object corresponding to a lighting condition, and the ground-truth image depicts the scene with the lighting condition. In some cases, the operations of this step refer to, or may be performed by, a training component as described with reference to FIG. 20.

In some embodiments, training component retrieves the training set from a database, such as the database 125 described with reference to FIG. 1. In some embodiments, a user provides the training set to the training component. In some embodiments, the source image is a source image as described with reference to FIG. 4. In some embodiments, the scene includes a foreground element and a background element as described with reference to FIG. 4. In some embodiments, the text prompt is a text prompt as described with reference to FIGS. 5-6. In some embodiments, the ground-truth image is a relighted image generated as described with reference to FIGS. 4 and 13.

According to some aspects, the training component performs spatial image augmentation, such as rotation, cropping, and/or padding, on the ground-truth image. According to some aspects, the training component swaps the source image and the ground-truth image (e.g., uses the source image as the ground-truth image and the ground-truth image as the source image). In some cases, the training component uses the language generation model 610 described with reference to FIG. 6 to generate the text prompt based on the original source image.

According to some aspects, the training component augments background contents of the source image by using the lighting image (e.g., an image or a panoramic image) as described with reference to FIG. 5 as a source background image, using the relighted foreground image as described with reference to FIG. 4 as a source foreground image, and compositing the source background image with the source foreground image to obtain the source image.

According to some aspects, the training component removes a shadow from the ground-truth image to obtain an augmented ground-truth image and augments the text prompt using the language generation model to refer to the removed shadow. In some aspects, the image generation model is trained based on the augmented ground-truth image and the augmented text prompt.

According to some aspects, the training component uses the background image relighting model 415 as described with reference to FIG. 4 to generate an augmented target image by adding a point light to the ground-truth image. For example, the training component synthesizes the augmented target image by dividing the ground-truth image into grid sections and assigning associated categories, e.g., top-right, center, and so on to the grid sections. At each grid section, the training component randomly samples the 3D position of a point light from a random distance. The training component picks a color from preset categories. The training component adds, moves, or removes one or more point lights to the ground-truth image using Eq. 4 using the detected surface normal and depth. The training prompt augments the text prompt using the language generation model to refer to the added point light. In some aspects, the image relighting model is trained based on the augmented ground-truth image and the augmented text prompt.

At operation 1610, the system trains, using the training set, an image generation model to generate a relighted image based on the text prompt, where the relighted image depicts the scene with the lighting condition. In some cases, the operations of this step refer to, or may be performed by, a training component as described with reference to FIG. 20.

In some embodiments, training the image generation model includes generating a predicted image using the image generation model, computing a loss function based on the predicted image and the ground-truth image, and updating the parameters of the image generation model based on the loss function.

In an example, the image generation model generates the predicted image based on the source image and the text prompt. The training component trains the image generation model to learn the objectives described in Eqs. 10 and 11:

$${ℒ}_{θ} ( x ) = w ( x ) \cdot {ℒ}_{T 2 R} ( x ) \qquad ( 10 )$$

$${ℒ}_{T 2 R} ( x ) = {‖ ϵ - {f}_{θ} ( \{ {z}_{t} , I , M \} , t , T ) ( x ) ‖}_{2}^{2} \qquad ( 11 )$$

In Eqs. 10 and 11, x is a latent pixel position, ϵ is a ground-truth noise corresponding to the ground-truth image, zₜ is an intermediate noisy latent corresponding to the predicted image at time t, f_{θ} is a learned denoiser that predicts the latent noise (e.g., a reverse diffusion process implemented by a U-Net), T is text, I is the source image, and M is a foreground element mask of the foreground element in the source image. In some embodiments, the training component detects the mask M using a masking machine learning model as described with reference to FIG. 4. The mask M is used to guide the image generation model with foregroundness so that the denoiser effectively learns from the ground-truth image. In some embodiments, the training component modifies an input layer of the U-Net comprising the image generation model to support a different channel number including the mask M.

w(x) is a function that balances a training weight between the foreground element and the background element to minimize background artifacts by avoiding data overfitting and maintaining the creativity from the image generation model. For example, in some embodiments, w(x) outputs 1 if x belongs to the foreground element and a smaller value (e.g., 0.001) otherwise.

Development of a lighting-specific model may be challenging due to a lack of data pairs for relighting, i.e., images of identical scene and main subject captured under different lighting conditions, associated by a text description. While some existing methods capture relighting data using expensive infrastructure such as a light stage system, such lab-controlled data are often not scalable (particularly for an axis of human identities), and a rendering of image relighting is often applicable to only a foreground human region, and where a background scene is simply composed with a part of preset panorama images. This limited imaging data, in turn, restricts a diversity of labeled text prompts as well.

Accordingly, some embodiments of the present disclosure provide a scalable data generation process that synthesizes relighting data of a scene for both a foreground and a background, and an associated text prompt for the scene:

$${\tilde{I}}_{gt} = r ( I , E ) = r ( I , e ( T ) ) = r ( I , e ( LGM ( ∞ ) ) ) \qquad ( 12 )$$

In Eq. 12, Ĩ_{gt} is a ground-truth relighted image, r is a relighting function that transfers a lighting condition from a lighting image E to both a foreground element and a background element of a source image I, e is a function that generates the lighting image E based on a text prompt T, and ∞ is a crafted language hierarchy that enables unlimited generation of diverse text prompts from a language generation model LGM.

According to some aspects, the data generation process is provided in a bottom-up fashion, from text generation to text-aware lighting image generation and to image-based relighting. In an example, a language generation model automatically generates diverse and creative text prompts based on a crafted language hierarchy to describe a lighting condition of a scene, a text-guided lighting image generation model generates lighting images as conditions of the text prompts, and lighting distributions of the generated lighting images are transferred to source images using various image-based relighting methods. In some embodiments, the image-based relighting is performed differently for background and foreground based on factors including data availability, algorithm maturity, and scene complexity, thereby providing a more accurate relighted image.

According to some aspects, an end-to-end foreground image relighting model is provided that can control a lighting of an input image as a function of a lighting image. In some embodiments, when OLAT images are available from a light stage, embodiments of the present disclosure apply HDR rendering techniques using a generated panoramic image. The end-to-end foreground image relighting model can be applied to any in-the-wild foreground image, such as a portrait scene.

According to some aspects, the lighting image is represented as a set of point lights with positions initialized with a distance-based localization algorithm and jointly optimized with other learnable variables (e.g., intensity and diffusion parameters) by minimizing a photometric difference from the lighting image. In some embodiments, a background image relighting model relights a background image by transporting the optimized light sources to the background image using inverse rendering techniques.

According to some aspects, a lighting-specific foundational model is developed using the training data generated according to the data generation process. In some embodiments, in training time, the model jointly learns with an auxiliary task such as portrait shadow removal and text-guided light positioning to improve a geometric awareness and better intrinsic appearance modeling.

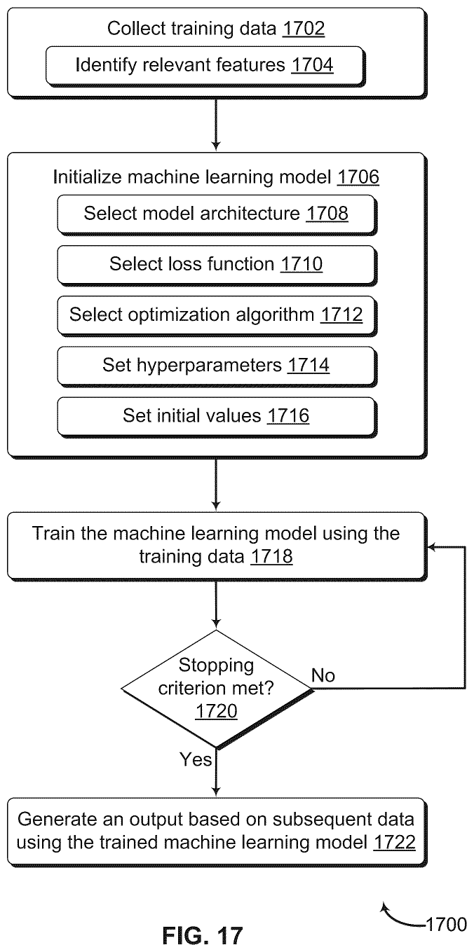

FIG. 17 shows an example of a flow diagram depicting an algorithm as a step-by-step procedure 1700 for training a machine learning model according to aspects of the present disclosure. In some embodiments, the procedure 1700 describes an operation of the training component 2025 described for configuring the image generation model 2015 as described with reference to FIG. 20. The procedure 1700 provides one or more examples of generating training data, use of the training data to train a machine learning model, and use of the trained machine learning model to perform a task.

To begin in this example, a machine learning system collects training data (block 1702) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1704) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1706). Initialization of the machine learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1710). The loss function is utilized to measure a difference between an output of the machine learning model (i.e., predictions) and target values (e.g., as expressed by the training data) to be used to train the machine learning model. Additionally, an optimization algorithm is selected (1712) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1714) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1718) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1720), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), the procedure 1700 continues training of the machine learning model using the training data (block 1718) in this example.

If the stopping criterion is met (“yes” from decision block 1720), the trained machine learning model is then utilized to generate an output based on subsequent data (block 1722). The trained machine learning model, for instance, is trained to perform a task as described above and therefore once trained is configured to perform that task based on subsequent data received as an input and processed by the machine learning model.

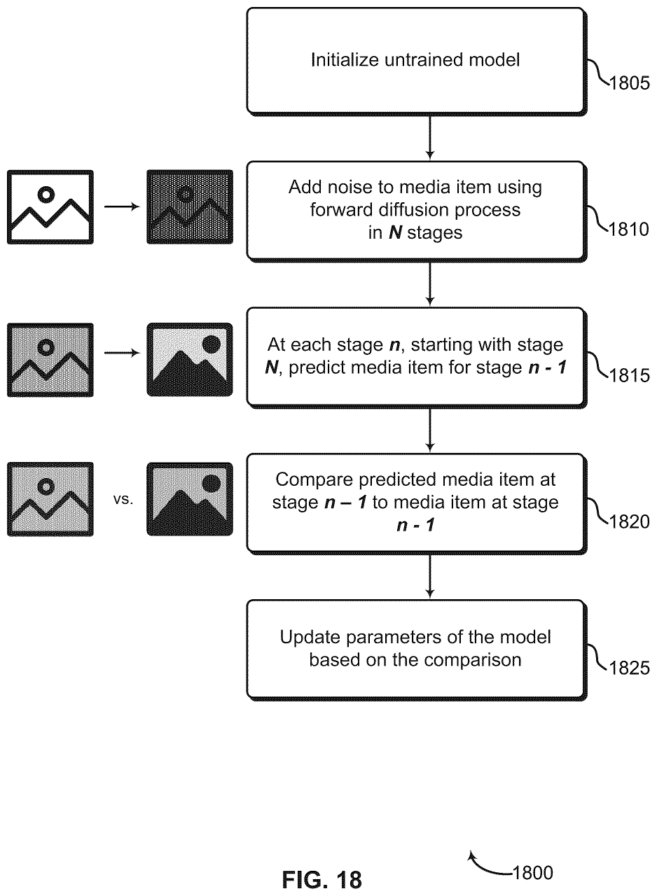

FIG. 18 shows an example of a method 1800 for training a diffusion model according to aspects of the present disclosure. In some embodiments, the method 1800 describes an operation of the training component 2025 described for configuring the image generation model 2015 as described with reference to FIG. 20. The method 1800 represents an example for training a reverse diffusion process as described above with reference to FIG. 15. In some examples, these operations are performed by a system including a processor executing a set of codes to control functional elements of an apparatus, such as the guided diffusion model described in FIG. 10.

Additionally or alternatively, certain processes of method 1800 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1805, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1810, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1815, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1820, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1825, the system updates parameters of the model based on the comparison. For example, parameters of a U-Net may be updated using gradient descent. Time-dependent parameters of the Gaussian transitions can also be learned.

Accordingly, a method for training an image generation model is described. One or more aspects of the method include obtaining a training set including a source image, a text prompt, and a ground-truth image. In some aspects, the source image depicts a scene, the text prompt describes a relighting object corresponding to a lighting condition, and the ground-truth image depicts the scene with the lighting condition. Some examples of the method further include training, using the training set, an image generation model to generate a relighted image based on the text prompt. In some aspects, the relighted image depicts the scene with the lighting condition.

In some examples of the method, training the image generation model comprises generating a predicted image, computing a loss function based on the predicted image and the ground-truth image, and updating the parameters of the image generation model based on the loss function. In some examples of the method, obtaining the training set comprises identifying a sensory category, selecting a word based on the sensory category, and generating the text prompt to include the selected word.

In some examples of the method, obtaining the training set comprises generating a lighting image depicting the lighting condition based on the text prompt and generating the ground-truth image based on the lighting image. In some examples of the method, obtaining the training set further comprises extracting a foreground image and a background image from the source image. In some aspects, the foreground image depicts a foreground element and the background image depicts a background element.

In some examples of the method, obtaining the training set further comprises obtaining a noise map and denoising the noise map based on the foreground image and the lighting image to obtain a relighted foreground image. In some aspects, the ground-truth image is obtained based on the relighted foreground image.

In some examples of the method, obtaining the training set further comprises extracting albedo information, depth information, and surface normal information from the lighting image, and transferring the lighting condition from the lighting image to the background image based on the albedo information, the depth information, and the surface normal information to obtain a relighted background image. In some aspects, the ground-truth image is obtained based on the relighted background image.

In some examples of the method, obtaining the training set further comprises identifying a plurality of point lights from the lighting image and transferring the lighting condition from the plurality of point lights to the background image based on the albedo information, the depth information, and the surface normal information to obtain a relighted background image. In some aspects, the ground-truth image is obtained based on the relighted background image.

Some examples of the method further include removing a shadow from the ground-truth image to obtain an augmented ground-truth image. Some examples further include augmenting the text prompt to refer to the removed shadow. In some aspects, the image generation model is trained based on the augmented ground-truth image and the augmented text prompt.

Some examples of the method further include generating an augmented target image by adding a point light to the ground-truth image. Some examples further include augmenting the text prompt to refer to the added point light. In some aspects, the image relighting model is trained based on the augmented ground-truth image and the augmented text prompt.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Computing Apparatus

FIG. 19 shows an example of a computing device 1900 according to aspects of the present disclosure. The computing device 1900 may be an example of the image generation apparatus 2000 described with reference to FIG. 20. In one aspect, computing device 1900 includes processor(s) 1905, memory subsystem 1910, communication interface 1915, I/O interface 1920, user interface component(s) 1925, and channel 1930.

In some embodiments, computing device 1900 is an example of, or includes aspects of, the image generation model of FIG. 10. In some embodiments, computing device 1900 includes one or more processors 1905 that can execute instructions stored in memory subsystem 1910 to perform image generation.

According to some aspects, computing device 1900 includes one or more processors 1905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or via hardware components controlled by the I/O controller.

According to some aspects, user interface component(s) 1925 enable a user to interact with computing device 1900. In some cases, user interface component(s) 1925 include an audio device, such as an external speaker system, an external display device such as a display screen, an input device (e.g., a remote-control device interfaced with a user interface directly or through the I/O controller), or a combination thereof. In some cases, user interface component(s) 1925 include a GUI.

FIG. 20 shows an example implementation of an image generation apparatus 2000 according to aspects of the present disclosure. Image generation apparatus 2000 may include an example of, or aspects of, the guided diffusion model described with reference to FIG. 10 and the U-Net described with reference to FIG. 11. In some embodiments, image generation apparatus 2000 includes processor unit 2005, memory unit 2010, image generation model 2015, I/O module 2020, and training component 2025. Training component 2025 updates parameters of the image generation model 2015 stored in memory unit 2010. In some examples, the training component 2025 is located outside the image generation apparatus 2000.

Processor unit 2005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 2005 is configured to operate a memory array using a memory controller. In other cases, a memory controller is integrated into processor unit 2005. In some cases, processor unit 2005 is configured to execute computer-readable instructions stored in memory unit 2010 to perform various functions. In some aspects, processor unit 2005 includes special purpose components for modem processing, baseband processing, digital signal processing, or transmission processing. According to some aspects, processor unit 2005 comprises one or more processors 1905 described with reference to FIG. 19.

Memory unit 2010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 2005 to perform various functions described herein.

In some cases, memory unit 2010 includes a basic input/output system (BIOS) that controls basic hardware or software operations, such as an interaction with peripheral components or devices. In some cases, memory unit 2010 includes a memory controller that operates memory cells of memory unit 2010. For example, the memory controller may include a row decoder, column decoder, or both. In some cases, memory cells within memory unit 2010 store information in the form of a logical state. According to some aspects, memory unit 2010 is an example of the memory subsystem 1910 described with reference to FIG. 19.

According to some aspects, image generation apparatus 2000 uses one or more processors of processor unit 2005 to execute instructions stored in memory unit 2010 to perform functions described herein. For example, the image generation apparatus 2000 may perform operation comprising obtaining a foreground image, a background image, and a lighting image, wherein the foreground image depicts a foreground element, the background image depicts a background element, and the lighting image depicts a lighting condition; generating a relighted foreground image based on the foreground image and on the lighting image, wherein the relighted foreground image depicts the foreground element with the lighting condition; generating a relighted background image based on the background image and on the lighting image, wherein the relighted background image depicts the background element with the lighting condition; and generating a relighted image by combining the relighted foreground image and the relighted background image, wherein the relighted image depicts the foreground element and the background element with the lighting condition.

The memory unit 2010 may include an image generation model 2015 trained to generate a relighted image based on the text prompt, wherein the relighted image depicts the scene with the lighting condition. For example, after training, the image generation model 2015 may perform inferencing operations as described with reference to FIGS. 14 and 15 to generate a relighted image with a lighting condition based on a text prompt describing the lighting condition.

In some embodiments, the image generation model 2015 is an artificial neural network (ANN) such as the guided diffusion model described with reference to FIG. 10 and the U-Net described with reference to FIG. 11. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the image generation model 2015 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 2025 may train the image generation model 2015. For example, parameters of the image generation model 2015 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 16-18). The goal of the training process may be to find optimal values for the parameters that allow the image generation model 2015 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 2015 can be used to make predictions on new, unseen data (i.e., during inference).

I/O module 2020 receives inputs from and transmits outputs of the image generation apparatus 2000 to other devices or users. For example, I/O module 2020 receives inputs for the image generation model 2015 and transmits outputs of the image generation model 2015. According to some aspects, I/O module 2020 is an example of the I/O interface 1920 described with reference to FIG. 19.

According to some aspects, training component 2025 comprises software stored in memory unit 2010, firmware, one or more hardware circuits, or a combination thereof. According to some aspects, training component 2025 creates a dataset including the relighted image. In some examples, training component 2025 trains the image generation model using the dataset.

According to some aspects, training component 2025 obtains a training set including a source image, a text prompt, and a ground-truth image, where the source image depicts a scene, the text prompt describes a relighting object corresponding to a lighting condition, and the ground-truth image depicts the scene with the lighting condition. In some examples, training component 2025 trains, using the training set, image generation model 2015 to generate a relighted image based on the text prompt, where the relighted image depicts the scene with the lighting condition. In some examples, training component 2025 computes a loss function based on the predicted image and the ground-truth image. In some examples, training component 2025 updates the parameters of image generation model 2015 based on the loss function.

Accordingly, a system and apparatus for image generation are described. One or more aspects of the system and apparatus include a memory component and a processing device coupled to the memory component. In some aspects, the processing device is configured to perform operations comprising generating, using an image generation model comprising machine learning parameters stored in the memory component, a relighted image with a lighting condition based on a text prompt describing the lighting condition. In some aspects, the image generation model is trained using a training set including a source image, the text prompt, and a ground-truth image. In some aspects, the source image depicts a scene, the text prompt describes a relighting object corresponding to a lighting condition, and the ground-truth image depicts the scene with the lighting condition.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining a source image and a lighting input, wherein the lighting input indicates a lighting condition for the source image;
generating, using an image generation model, a relighted foreground image and a relighted background image based on the source image and on the lighting input, wherein the relighted foreground image depicts a foreground element with the lighting condition and the relighted background image depicts a background element with the lighting condition; and
combining the relighted foreground image and the relighted background image to obtain a relighted image, wherein the relighted image depicts the foreground element and the background element with the lighting condition.

2. The method of claim 1, further comprising:
extracting a foreground image and a background image from the source image, wherein the relighted foreground image is based on the foreground image and the relighted background image is based on the background image.

3. The method of claim 2, wherein:
the foreground image depicts a plurality of versions of the foreground element under different lighting conditions and the lighting image comprises a panoramic image.

4. The method of claim 1, wherein further comprising:
generating a lighting image based on the lighting input, wherein the relighted foreground image is based on the lighting image.

5. The method of claim 1, wherein obtaining the lighting input comprises:
identifying a sensory category;
selecting a word based on the sensory category; and
generating the lighting input to include the selected word.

6. The method of claim 1, wherein generating the relighted foreground image comprises:
obtaining a noise map; and
denoising the noise map based on the lighting input.

7. The method of claim 1, wherein generating the relighted background image comprises:
determining albedo information, depth information, and surface normal information based on the lighting input; and
transferring the lighting condition from the lighting image to the background image based on the albedo information, the depth information, and the surface normal information.

8. The method of claim 7, wherein generating the relighted background image comprises:
identifying a plurality of point lights based on the lighting input; and
transferring the lighting condition from the plurality of point lights to the background image based on the albedo information, the depth information, and the surface normal information.

9. The method of claim 1, further comprising:
creating a dataset including the relighted image; and
training an image generation model using the dataset.

10. A method of training an image generation model comprising parameters stored in a non-transitory computer-readable medium, the method comprising:
obtaining a training set including a source image, a text prompt, and a ground-truth image, wherein the source image depicts a scene, the text prompt describes a relighting object corresponding to a lighting condition, and the ground-truth image depicts the scene with the lighting condition; and
training, using the training set, the image generation model to generate a relighted image based on the text prompt, wherein the relighted image depicts the scene with the lighting condition.

11. The method of claim 10, wherein training the image generation model comprises:
generating a predicted image;
computing a loss function based on the predicted image and the ground-truth image; and
updating the parameters of the image generation model based on the loss function.

12. The method of claim 10, wherein obtaining the training set comprises:
identifying a sensory category;
selecting a word based on the sensory category; and
generating the text prompt to include the selected word.

13. The method of claim 10, wherein obtaining the training set comprises:
generating a lighting image depicting the lighting condition based on the text prompt; and
generating the ground-truth image based on the lighting image.

14. The method of claim 10, wherein obtaining the training set further comprises:
extracting a foreground image and a background image from the source image, wherein the foreground image depicts a foreground element and the background image depicts a background element.

15. The method of claim 14, wherein obtaining the training set further comprises:
extracting albedo information, depth information, and surface normal information from the lighting image; and
transferring the lighting condition from the lighting image to the background image based on the albedo information, the depth information, and the surface normal information to obtain a relighted background image, wherein the ground-truth image is obtained based on the relighted background image.

16. The method of claim 15, wherein obtaining the training set further comprises:
identifying a plurality of point lights from the lighting image; and
transferring the lighting condition from the plurality of point lights to the background image based on the albedo information, the depth information, and the surface normal information to obtain a relighted background image, wherein the ground-truth image is obtained based on the relighted background image.

17. The method of claim 10, further comprising:
removing a shadow from or adding a light point to the ground-truth image to obtain an augmented ground-truth image; and
augmenting the text prompt to refer to the removed shadow or the light point, wherein the image generation model is trained based on the augmented ground-truth image and the augmented text prompt.

18. A system for image generation, comprising:
a memory component; and
a processing device coupled to the memory component, the processing device configured to perform operations comprising:
obtaining a source image and a lighting input, wherein the lighting input indicates a lighting condition for the source image;
generating, using an image generation model, a relighted foreground image and a relighted background image based on the source image and on the lighting input, wherein the relighted foreground image depicts a foreground element with the lighting condition and the relighted background image depicts a background element with the lighting condition; and
combining the relighted foreground image and the relighted background image to obtain a relighted image, wherein the relighted image depicts the foreground element and the background element with the lighting condition.

19. The system of claim 18, wherein the processing device is further configured to perform operations comprising:
extracting a foreground image and a background image from the source image, wherein the relighted foreground image is based on the foreground image and the relighted background image is based on the background image.

20. The system of claim 19, wherein generating the relighted foreground image comprises:
generating a lighting image based on the lighting input, wherein the relighted foreground image is based on the lighting image.
